(19) United States
(12) Patent Application Publication
(10) Pub. No.: US 2025/0068626 A1
(43) Pub. Date: Feb. 27, 2025

(54) TECHNIQUES FOR MANUFACTURING TRAINING DATA TO TRANSFORM NATURAL LANGUAGE INTO A VISUALIZATION REPRESENTATION

(71) Applicant: Oracle International Corporation, Redwood Shores, CA (US)

(72) Inventors: Gioacchino Tangari, Sydney (AU); Steve Wai-Chun Siu, Melbourne (AU); Dalu Guo, Sydney (AU); Cong Duy Vu Hoang, Wantirna South (AU); Berk Sarioz, Mountain View, CA (US); Chang Xu, Sydney (AU); Stephen Andrew McRitchie, Palo Alto, CA (US); Mark Edward Johnson, Sydney (AU); Christopher Mark Broadbent, Wellington, FL (US); Thanh Long Duong, Melbourne (AU); Srinivasa Phani Kumar Gadde, Fremont, CA (US); Vishal Vishnoi, Redwood City, CA (US); Chandan Basavaraju, Bangalore (IN); Kenneth Khiaw Hong Eng, Newark, CA (US)

(73) Assignee: Oracle International Corporation, Redwood Shores, CA (US)

(21) Appl. No.: 18/593,316

(22) Filed: Mar. 1, 2024

Related U.S. Application Data
(60) Provisional application No. 63/582,931, filed on Sep. 15, 2023.
(60) Provisional application No. 63/520,877, filed on Aug. 21, 2023.

(51) Int. Cl. G06F 16/2452; G06F 16/28

(52) U.S. Cl. CPC G06F 16/24522; G06F 16/287

(57) ABSTRACT

The present disclosure relates to manufacturing training data by leveraging an automated pipeline that manufactures visualization training datasets to train a machine learning model to convert a natural language utterance into meaning representation language logical form that includes one or more visualization actions. Aspects are directed towards accessing an original training dataset, a visualization query dataset, an incremental visualization dataset, a manipulation visualization dataset, or any combination thereof. One or more visualization training datasets are generated by: (i) modifying examples in the original training dataset, the visualization query dataset, or both to include visualization actions, (ii) generating examples, using the incremental visualization dataset, the manipulation visualization dataset, or both, that include visualization actions, or (iii) both (i) and (ii). An augmented training dataset is generated by adding the one or more visualization training datasets to the original training dataset and then used to train the machine learning model.

### CROSS-REFERENCE TO RELATED APPLICATIONS

The present application is a non-provisional application of and claims the benefit and priority under 35 U.S.C. 119 (e) of U.S. Provisional Application No. 63/582,931, filed Sep. 15, 2023, and U.S. Provisional Application No. 63/520,877, filed Aug. 21, 2023, the entire contents of which are incorporated herein by reference for all purposes.

### FIELD

The present disclosure relates generally to converting natural language to a logical form, and more particularly, to artificial intelligence-based techniques for manufacturing visualization training data to be used for training a machine learning model to transform natural language into a visualization representation.

### BACKGROUND

Artificial intelligence has many applications. To illustrate, many users around the world are on instant messaging or chat platforms in order to get instant reaction. Organizations often use these instant messaging or chat platforms to engage with customers (or end users) in live conversations. However, it can be very costly for organizations to employ service people to engage in live communication with customers or end users. Chatbots or bots have begun to be developed to simulate conversations with end users, especially over the Internet. End users can communicate with bots through messaging apps that the end users have already installed and used. An intelligent bot, generally powered by artificial intelligence (AI), can communicate more intelligently and contextually in live conversations, and thus may allow for a more natural conversation between the bot and the end users for improved conversational experience. Instead of the end user learning a fixed set of keywords or commands that the bot knows how to respond to, an intelligent bot may be able to understand the end user's intention based upon user utterances in natural language and respond accordingly.

Artificial intelligence-based solutions, such as chatbots, may have both analog (human) and digital (machine) interfaces for interacting with a human and connecting to a backend system. It is advantageous to be able to extract and analyze the meaning of an utterance (e.g., a request) when a human makes one using natural language, independent of how a backend system will handle the utterance. As an example, a request might be for data that needs to be retrieved from a relational database, or the requested data might need to be extracted from a knowledge graph. A meaning representation language (MRL) is a versatile representation of a natural language utterance that a chatbot can translate into any number of target machine-oriented languages. As such, an MRL can be utilized by a chatbot to communicate interchangeably with both a human and various backend systems, including systems that communicate using Structured Query Language (SQL), Application Programming Interfaces (APIs), REpresentational State Transfer (REST), Graph Query Language (GraphQL), Property Graph Query Language (PGQL), etc.

For example, SQL is a standard database management language for interacting with relational databases. SQL can be used for storing, manipulating, retrieving, and/or otherwise managing data held in a relational database management system (RDBMS) and/or for stream processing in a relational data stream management system (RDSMS). SQL includes statements or commands that are used to interact with relational databases. SQL statements or commands are classified into, among others, data query language (DQL) statements, data definition language (DDL) statements, data control language (DCL) statements, and data manipulation language (DML) statements. To interact with relational databases using SQL, users must know how the database is structured (e.g., knowledge of the tables and rows and columns within each table), SQL syntax, and how to relate the syntax to the database structure. Without this knowledge, users often have difficultly using SQL to interact with these relational databases.

Natural language interfaces (e.g., chatbots) to databases systems (NLIDB) such as RDBMS provide users with a means to interact with these relational databases in an intuitive way without requiring knowledge of a database management language. For example, using natural language statement and queries (i.e., natural language querying), users can interact with these relational databases, via a NLIDB, with plain language. Recently, text-to-SQL systems have become popular and deep learning approaches to converting natural language queries to SQL queries have proved promising. Using semantic parsing, natural language statements, requests, and questions (i.e., sentences) can be transformed into machine-oriented language that can be executed by an application (e.g., chatbot, model, program, machine, etc.). For example, semantic parsing can transform natural language sentences into general purpose programming languages such as Python, Java, and SQL. Processes for transforming natural language sentences to SQL queries typically include rule-based, statistical-based, and/or deep learning-based systems. Rule-based systems typically use a series of fixed rules to translate the natural language sentences to SQL queries. These rule-based systems are generally domain-specific and, thus, are considered inelastic and do not generalize well to new use cases (e.g., across different domains). Statistical-based systems, such as slot-filling, label tokens (i.e., words or phrases) in an input natural language sentence according to their semantic role in the sentence and use the labels to fill slots in the SQL query. Generally, these statistical-based systems have limitations on the types of sentences that can be parsed (e.g., a sentence must be able to be represented as a parse tree). Deep-learning based systems, such as sequence-to-sequence models, involve training deep-learning models that directly translate the natural language sentences to machine-oriented languages and have been shown to generalize across tasks, domains, and datasets. However, such deep-learning systems require a large amount of training data for supervised learning, and it is challenging to obtain labelled data (e.g., natural language query-SQL statement pairings). Thus, translating natural language sentences to machine-oriented languages based on deep-learning cannot avoid the need for a large amount of labelled training data.

### SUMMARY

Machine learning techniques are provided (e.g., a method, a system, non-transitory computer-readable medium storing code or instructions executable by one or more processors) for manufacturing visualization training data examples to be used for training a machine learning model to transform natural language into a logic form such as meaning representation languages (MRL) comprising a visualization representation.

In various embodiments, a computer-implemented method is provided comprising: accessing an original training dataset, a visualization query dataset, an incremental visualization dataset, a manipulation visualization dataset, or any combination thereof; generating one or more visualization training datasets by: (i) modifying examples in the original training dataset, the visualization query dataset, or both to include visualization actions, (ii) generating examples, using the incremental visualization dataset, the manipulation visualization dataset, or both, that include visualization actions, or (iii) both (i) and (ii); augmenting the original training dataset by adding the one or more visualization training datasets to the original training dataset to generate an augmented training dataset; and training, using the augmented training dataset, a machine learning model to convert a natural language utterance into meaning representation language (MRL) logical form that includes one or more visualization actions.

In some embodiments, (i) each example in the original training dataset comprises a natural language utterance, a MRL logical form corresponding to the natural language utterance, and a schema, (ii) each example in the visualization query dataset comprises a natural language utterance, a system programming language corresponding to the natural language utterance, a visualization type presented in the natural language utterance, and a schema, (iii) the incremental visualization dataset comprises one or more data annotation and incremental natural language templates, and (iv) the manipulation visualization dataset comprises one or more manipulation templates.

In some embodiments, modifying the examples in the original training dataset comprises: (a) accessing an example from the original training dataset; (b) adding, to the schema associated with the example, one or more visualization-related entities and schema-linking relations that link the one or more visualization-related entities to one or more entities within the schema to generate a visualization labeled schema; (c) selecting a visualization type for the example based on constraints of the MRL logical form and popularity scores associated to each visualization type; (d) adding a visualization clause to the natural language utterance associated with the example using a visualization clause template and the visualization type selected for the example to generate a visualization creation utterance, wherein the visualization clause includes a visualization action for the visualization type; (e) modifying, based on the visualization labeled schema and the visualization type selected for the example, the MRL logical form associated with the example to generate a visualization creation MRL logical form that corresponds to the visualization creation utterance, wherein the visualization creation MRL logical form comprises one or more visualization-related entities and a visualization clause that includes the visualization action for the visualization type; (f) assembling the visualization labeled schema, the visualization creation utterance, and the visualization creation MRL logical form to generate a new visualization example; and (g) repeating steps (a) and (c)-(f) for a random or predefined number of examples in the original training dataset to generate a visualization training dataset of the one or more visualization training datasets, the visualization training dataset comprising the new visualization examples.

In some embodiments, modifying the examples in the visualization query dataset comprises: (a) accessing an example from the visualization query dataset, wherein the natural language utterance associated with the example comprises a visualization clause that includes a visualization action for the visualization type; (b) converting the system programming language into MRL logical form corresponding to the natural language utterance; (c) adding, to the schema, one or more visualization-related entities and schema-linking relations that link the one or more visualization-related entities to one or more entities within the schema to generate a visualization labeled schema; (d) modifying, based on the visualization labeled schema and the visualization type presented in the natural language utterance, the MRL logical form to generate a visualization creation MRL logical form that corresponds to the natural language utterance, wherein the visualization creation MRL logical form comprises one or more visualization-related entities and a visualization clause that includes the visualization action for the visualization type; (e) assembling the visualization labeled schema, the natural language utterance, and the visualization creation MRL logical form to generate a new visualization example; and (f) repeating steps (a), (b), (d) and (e) for a random or predefined number of examples in the visualization query dataset to generate a visualization training dataset of the one or more visualization training datasets, the visualization training dataset comprising the new visualization examples.

In some embodiments, generating the examples, using the incremental visualization dataset, comprises: (a) accessing an incremental natural language template and data annotation from the incremental visualization dataset, wherein the incremental natural language template comprises a library of different text to be used for an incremental use-case type to be added to a visualization incremental utterance, and wherein the data annotation comprises a base utterance, an input MRL logical form, an incremental use-case type to be used in the visualization example utterance, and a schema; (b) adding, to the schema, one or more visualization-related entities and schema-linking relations that link the one or more visualization-related entities to one or more entities within the schema to generate a visualization labeled schema; (c) composing, based on the incremental natural language template, the base utterance, and the incremental use-case type, a visualization example utterance that comprises a visualization action for the incremental use-case type; (d) constructing, based on the input MRL logical form and a set of MRL logical form construction rules defined for the incremental use-case type, a visualization incremental MRL logical form; (e) assembling the visualization labeled schema, the visualization example utterance, and the visualization incremental MRL logical form to generate a new visualization example; and (f) repeating steps (a) and (c)-(e) for a random or predefined number of examples to generate a visualization training dataset of the one or more visualization training datasets, the visualization training dataset comprising the new visualization examples.

In some embodiments, generating the examples, using the manipulation visualization dataset, comprises: (a) accessing a manipulation template from the manipulation visualization dataset, wherein the manipulation template comprises a natural language utterance definition and a corresponding MRL logical form definition for a visualization manipulation use-case; (b) composing, using the manipulation template, a new visualization example comprising a visualization example utterance and a corresponding visualization manipulation MRL logical form; (c) repeating steps (a) and (b) for a random or predefined number of examples to generate a visualization training dataset of the one or more visualization training datasets, the visualization training dataset comprising the new visualization examples.

In some embodiments, modifying the examples in the original training dataset, the visualization query dataset, or both further comprises, after adding, to the schema associated with the example, determining whether the example is suitable for augmentation based on analysis of the MRL logical form using a set of filtering rules, and only performing (c)-(f) when the example is determined to be suitable for augmentation, and wherein the determination of whether the example is suitable for augmentation is performed for each example in the original training dataset that is accessed in accordance with (g) and (a).

In some embodiments, a system is provided that includes one or more processors and one or more computer-readable media storing instructions which, when executed by the one or more processors, cause the system to perform part or all of the operations and/or methods disclosed herein.

In some embodiments, one or more non-transitory computer-readable media are provided for storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present invention will be better understood in view of the following non-limiting figures, in which:

FIG. 1 is a simplified block diagram of a distributed environment incorporating an exemplary embodiment.

FIG. 2 is a simplified block diagram of a computing system implementing a master bot according to certain embodiments.

FIG. 3 is a simplified block diagram of a computing system implementing a skill bot according to certain embodiments.

FIG. 4 is a block diagram illustrating an overview of a C20MRL architecture and process for generating a query for a backend interface starting with a natural language utterance, in accordance with various embodiments.

FIG. 5 is a simplified block diagram of the C20MRL architecture in accordance with various embodiments.

FIG. 6 is a block diagram of a semi-automated data manufacturing framework that generates visualization queries to train a NL2LF architecture (e.g., the C20MRL architecture) in accordance with various embodiments.

FIG. 7 is a block diagram illustrating a pipeline for generating visualization training examples from existing training examples in accordance with various embodiments.

FIG. 8 is a block diagram illustrating a pipeline for generating visualization training examples from a visualization query dataset in accordance with various embodiments.

FIG. 9 is a block diagram illustrating a pipeline for generating visualization training examples from an incremental visualization dataset in accordance with various embodiments.

FIG. 10 is a block diagram illustrating a pipeline for generating visualization training examples from a manipulation visualization dataset in accordance with various embodiments.

FIG. 11 depicts a flow chart describing techniques for manufacturing training data to transform natural language conversations into visualization representations in accordance with various embodiments.

FIG. 12 depicts a simplified diagram of a distributed system for implementing various embodiments.

FIG. 13 is a simplified block diagram of one or more components of a system environment by which services provided by one or more components of an embodiment system may be offered as cloud services, in accordance with various embodiments.

FIG. 14 illustrates an example computer system that may be used to implement various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### I. Introduction

In recent years, the amount of data powering different industries and their systems has been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of its business in order to quickly understand and diagnose any emerging issues, trends, or anomalies in the data and take immediate corrective actions. This work is usually performed manually by analysts who compose complex queries in query languages (e.g., database query languages such as declarative query languages) like SQL, PGQL, logical database queries, API query languages such as GraphQL, REST, and so forth. Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results require time-consuming manual intervention and result in slow feedback cycles. It is vastly more efficient to have non-technical users (e.g., business leaders, doctors, or other users of the data) directly interact with the analytics tables via natural language (NL) queries that abstract away the underlying query language (e.g., SQL) code. Defining the database query requires a strong understanding of database schema and query language syntax and can quickly get overwhelming for beginners and non-technical stakeholders. Efforts to bridge this communication gap have led to the development of a new type of processing called NLIDB. This natural search capability has become more popular over recent years as companies are developing deep-learning approaches for natural language to logical form (NL2LF) such as natural language to SQL (NL2SQL). Logical form can refer to meaning representation languages and/or machine-oriented languages. NL2SQL seeks to transform natural language questions to SQL, allowing individuals to run unstructured queries against databases. The converted SQL could also enable digital assistants such as chatbots and others to improve their responses when the answer can be found in different databases or tables.

In the specific context of converting NL to a meaning representation language (MRL), a NL utterance (e.g., a user's question) is typically provided to a NL2LF model, which converts the NL utterance into a logical form, for example, a MRL having intermediate representations. The NL2LF model is a machine learning model trained to generate intermediate representations from NL utterances. The intermediate representations can then be translated to one or more desired query formats, such as SQL or PGQL using a translation process. Thereafter, the utterance in the desired query format may be executed on a backend system supporting the desired query format such as database to obtain data relevant to the query and formulate a response to the NL utterance (e.g., an answer to the user's question) for review by a user.

In some instances, the intermediate representations are in a language called Oracle Meaning Representation Language (OMRL) [also known or described as Oracle Meaning Representation Query Language (OMRQL)], and a Conversation to Oracle Meaning Representation Language (C20MRL) system performs the conversion of the natural language utterance to the logical form. The C20MRL system is powered by a deep learning model configured to convert a NL utterance (or a conversation within the Oracle Digital Assistant platform) into a logical form in an intermediate database query language such as OMRL. The logical form can be used to generate a query in a specific database query language (e.g., SQL), which can then be executed for querying an existing database.

However, conventional NL2LF models generally only support text-based use cases (e.g., find the number of universities that have more than 2000 enrollment size for each affiliation type). A highly attractive next step for NL2LF models is to support visualization-based use cases (e.g., create a data visualization such as graphs and charts as well as animations with the number of universities that have more than 2000 enrollment size for each affiliation type). The reason that conventional NL2LF models are not trained and/or structured to convert natural language to visualizations (NL2VIS) is largely due to the extreme deficit of large-scale and high-quality benchmark training data. Unfortunately, the C20MRL system is not immune to such challenges. Until now, the C20MRL system was trained with general-domain datasets in the order of thousands of examples, but none of them contained visualization or visualization manipulation entities/attributes. As a result, the models were not trained to support visualization utterances, and thus performed poorly on generating visualization representations when input NL queries comprised a request for a visualization. To illustrate this point, Table 1 shows examples of OMRQL predictions using conventional C20MRL models and visualization-enabled schemas.

TABLE 1

| | Query | Expected OMRQL for visualizations in | Predicted OMRQL (with |
|---|---|---|---|
| NL Query | Category | Oracle Analytics Cloud (OAC) | conventional C2OMRL Model) |
| pivot table of | Visual (Viz) | SELECT COUNT(DISTINCT order_id_fwd- | SELECT product_category, |
| the number | Creation | link-to_orders-id.customer_name), | COUNT(DISTINCT |
| of distinct | | order_id_fwd-link-to_orders- | customer_name) FROM |
| customer | | id.product_category, visualize_id_fwd-link- | orders WHERE |
| names for | | to_visualize_action-id.visualize FROM | product_category LIKE |
| each product | | display WHERE chart_type = ‘pivot table’ | ‘%pivot table%’ GROUP |
| category | | GROUP BY order_id_fwd-link-to_orders- | BY product_category |
| | | id.product_category | |
| create a bar | Viz Creation | SELECT order_id_fwd-link-to_orders- | SELECT order_id_fwd- |
| chart | | id.profit, order_id_fwd-link-to_orders- | link-to_orders-id.profit |
| showing the | | id.order_date, visualize_id_fwd-link- | FROM display WHERE |
| profit for | | to_visualize_action-id.visualize FROM | chart_type = ‘bar chart’ |
| each order | | display WHERE chart_type = ‘bar chart’ | |
| date | | GROUP BY order_id_fwd-link-to_orders- | |
| | | id.order_date | |
| add a filter | Viz Incremental | SELECT include_filter_id_fwd-link- | SELECT sales FROM |
| on Sales | (refine the | to_include_filter_action- | orders |
| greater than | meaning of a | include_filter_id.include_filter FROM | |
| 2.5 million | previous Viz | display_element WHERE orders_id_fwd-link- | |
| | Creation query) | to_orders-orders_id.sales > 2500000 | |
| switch the | Viz | SELECT update_id_fwd-link- | SELECT * FROM display |
| chart type to | Manipulation | to_update_action-update_id.update FROM | WHERE chart_type = ‘Pie’ |
| pie chart | (modify the | display WHERE chart_type = ‘Pie’ | |
| | properties of the | | |
| | visualization, | | |
| | e.g., chart_type, | | |
| | legend, etc.) | | |

The results presented in Table 1 illustrate the clear need for additional visualization training data if the C20MRL system is to be used for generating visual representations of data. Although this data is specific to the C20MRL system and in many instances the artificial intelligence-based techniques are described herein within the context of the C20MRL system, it should be understood that similar data would be seen in most, if not all, NL2LF systems and models that were not specifically trained to support visualization utterances and the artificial intelligence-based techniques described herein are applicable to other NL2LF systems and/or models configured to generate other intermediate representation formats.

Accordingly, different approaches are needed to address these challenges and others. The developed approaches described herein leverage a data manufacturing pipeline that (semi-) automatically generates training examples via various augmentation and synthesization techniques for various types of visualization use-cases, which may then be used for training NL2LF models. More specifically, the data manufacturing pipeline includes a first path that generates training examples via various augmentation techniques for creation type visualization queries (described herein as Viz-Creation training examples) to train NL2LF models. The creation type visualization utterances or queries are natural language utterances and corresponding logical forms that request a system (e.g., Oracle Analytics Cloud (OAC)) to generate or create a visualization (e.g., a chart or graph) for a given set of data. These approaches use a set of targeted rules to determine if the logical form of an existing query (e.g., OMRL query, SQL query) makes sense for visualization, results in higher-quality output examples, due to a much stricter filtering criterion. Moreover, the quality of the original natural language utterances (compared to fully synthetic natural language utterances) is retained. Additionally, these approaches include visualization-type selection logic, which selects a suitable visualization-type (e.g., bar chart versus pie chart) based on the logical form (e.g., OMRQL) properties.

The data manufacturing pipeline also includes a second and third path that generates training examples via various augmentation and synthesization techniques for modification and incremental type visualization queries (described herein as Viz-Manipulation and Viz-Incremental training examples) to train NL2LF models. The manipulation type visualization utterances or queries are natural language utterances and corresponding logical forms that request a system (e.g., OAC) to modify the properties of a prior visualization, e.g., modify chart_type, legend, etc. The incremental type visualization utterances or queries are natural language utterances and corresponding logical forms that request a system (e.g., OAC) to refine the meaning of a previous Viz Creation query, e.g., add or remove a filter on certain data, add or remove data points, add or remove attributes, etc. Advantageously with respect to the Viz-Incremental training examples, the complexity of viz-enabled schemas (and LF/OMRL representations) is hidden to the data annotators and the data annotators only need to provide a minimal (utterance, logical form) input. The final natural language utterances and logical forms (e.g., OMRQL) are automatically generated with a conversion rules library. Advantageously with respect to the Viz-Manipulation training examples, a collection of Viz-Manipulation Query Templates is used which simplifies and helps automate the generation of numerous diverse training examples.

To illustrate the significant improvement the data manufacturing pipeline described herein has on generating visualization queries, when the nvBench Public dataset was input into the data manufacturing pipeline, nearly 85% of the 7K+ visualization examples were filtered out for not satisfying the strict, high quality constrains imposed by the pipeline. Moreover, the data manufacturing pipeline generated more than 10K high quality training examples for visualization use-cases, which resulted in drastically improved C20MRL model accuracy, from 0% to 90%+ on the creation, refinement, and manipulation of visualization examples as illustrated in Table 2.

TABLE 2

| | Viz-Creation | Viz-Incremental | Viz-Manipulation |
|---|---|---|---|
| | Test-set | Test-set | Test-set |
| | (Customer | (Customer | (Customer |
| Model | queries) | queries) | queries) |
| Conventional | 0% | 0% | 0% |
| C2OMRL Model | | | |
| New C2OMRL | 97% | 93% | 99% |
| Model with proposed | | | |
| Data Manufacturing | | | |

In various embodiments, a computer-implemented method is provided comprising: accessing an original training dataset, a visualization query dataset, an incremental visualization dataset, a manipulation visualization dataset, or any combination thereof; generating one or more visualization training datasets by: (i) modifying examples in the original training dataset, the visualization query dataset, or both to include visualization actions, (ii) generating examples, using the incremental visualization dataset, the manipulation visualization dataset, or both, that include visualization actions, or (iii) both (i) and (ii); augmenting the original training dataset by adding the one or more visualization training datasets to the original training dataset to generate an augmented training dataset; and training, using the augmented training dataset, a machine learning model to convert a natural language utterance into meaning representation language (MRL) logical form that includes one or more visualization actions.

As used herein, when an action is “based on” something, this means the action is based at least in part on at least a part of the something. As used herein, the terms “similarly”, “substantially,” “approximately” and “about” are defined as being largely but not necessarily wholly what is specified (and include wholly what is specified) as understood by one of ordinary skill in the art. In any disclosed embodiment, the term “similarly”, “substantially,” “approximately,” or “about” may be substituted with “within [a percentage] of” what is specified, where the percentage includes 0.1, 1, 5, and 10 percent.

### II. Bot and Analytic Systems

A bot (also referred to as a skill, chatbot, chatterbot, or talkbot) is a computer program that can perform conversations with end users. The bot can generally respond to natural-language messages (e.g., questions or comments) through a messaging application that uses natural-language messages. Enterprises may use one or more bot systems to communicate with end users through a messaging application. The messaging application, which may be referred to as a channel, may be an end user preferred messaging application that the end user has already installed and familiar with. Thus, the end user does not need to download and install new applications in order to chat with the bot system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

In some examples, a bot system may be associated with a Uniform Resource Identifier (URI). The URI may identify the bot system using a string of characters. The URI may be used as a webhook for one or more messaging application systems. The URI may include, for example, a Uniform Resource Locator (URL) or a Uniform Resource Name (URN). The bot system may be designed to receive a message (e.g., a hypertext transfer protocol (HTTP) post call message) from a messaging application system. The HTTP post call message may be directed to the URI from the messaging application system. In some embodiments, the message may be different from a HTTP post call message. For example, the bot system may receive a message from a Short Message Service (SMS). While discussion herein may refer to communications that the bot system receives as a message, it should be understood that the message may be an HTTP post call message, a SMS message, or any other type of communication between two systems.

End users may interact with the bot system through a conversational interaction (sometimes referred to as a conversational user interface (UI)), just as interactions between people. In some cases, the interaction may include the end user saying “Hello” to the bot and the bot responding with a “Hi” and asking the end user how it can help. In some cases, the interaction may also be a transactional interaction with, for example, a banking bot, such as transferring money from one account to another; an informational interaction with, for example, a HR bot, such as checking for vacation balance; or an interaction with, for example, a retail bot, such as discussing returning purchased goods or seeking technical support.

In some embodiments, the bot system may intelligently handle end user interactions without interaction with an administrator or developer of the bot system. For example, an end user may send one or more messages to the bot system in order to achieve a desired goal. A message may include certain content, such as text, emojis, audio, image, video, or other method of conveying a message. In some embodiments, the bot system may convert the content into a standardized form (e.g., a representational state transfer (REST) call against enterprise services with the proper parameters) and generate a natural language response. The bot system may also prompt the end user for additional input parameters or request other additional information. In some embodiments, the bot system may also initiate communication with the end user, rather than passively responding to end user utterances. Described herein are various techniques for identifying an explicit invocation of a bot system and determining an input for the bot system being invoked. In certain embodiments, explicit invocation analysis is performed by a master bot based on detecting an invocation name in an utterance. In response to detection of the invocation name, the utterance may be refined for input to a skill bot associated with the invocation name.

A conversation with a bot may follow a specific conversation flow including multiple states. The flow may define what would happen next based on an input. In some embodiments, a state machine that includes user defined states (e.g., end user intents) and actions to take in the states or from state to state may be used to implement the bot system. A conversation may take different paths based on the end user input, which may impact the decision the bot makes for the flow. For example, at each state, based on the end user input or utterances, the bot may determine the end user's intent in order to determine the appropriate next action to take. As used herein and in the context of an utterance, the term “intent” refers to an intent of the user who provided the utterance. For example, the user may intend to engage a bot in conversation for ordering pizza, so that the user's intent could be represented through the utterance “Order pizza.” A user intent can be directed to a particular task that the user wishes a chatbot to perform on behalf of the user. Therefore, utterances can be phrased as questions, commands, requests, and the like, that reflect the user's intent. An intent may include a goal that the end user would like to accomplish.

In the context of the configuration of a chatbot, the term “intent” is used herein to refer to configuration information for mapping a user's utterance to a specific task/action or category of task/action that the chatbot can perform. In order to distinguish between the intent of an utterance (i.e., a user intent) and the intent of a chatbot, the latter is sometimes referred to herein as a “bot intent.” A bot intent may comprise a set of one or more utterances associated with the intent. For instance, an intent for ordering pizza can be communicated by various permutations of utterances that express a desire to place an order for pizza. These associated utterances can be used to train an intent classifier of the chatbot to enable the intent classifier to subsequently determine whether an input utterance from a user matches the order pizza intent. A bot intent may be associated with one or more dialog flows for starting a conversation with the user and in a certain state. For example, the first message for the order pizza intent could be the question “What kind of pizza would you like?” In addition to associated utterances, a bot intent may further comprise named entities that relate to the intent. For example, the order pizza intent could include variables or parameters used to perform the task of ordering pizza, e.g., topping 1, topping 2, pizza type, pizza size, pizza quantity, and the like. The value of an entity is typically obtained through conversing with the user.

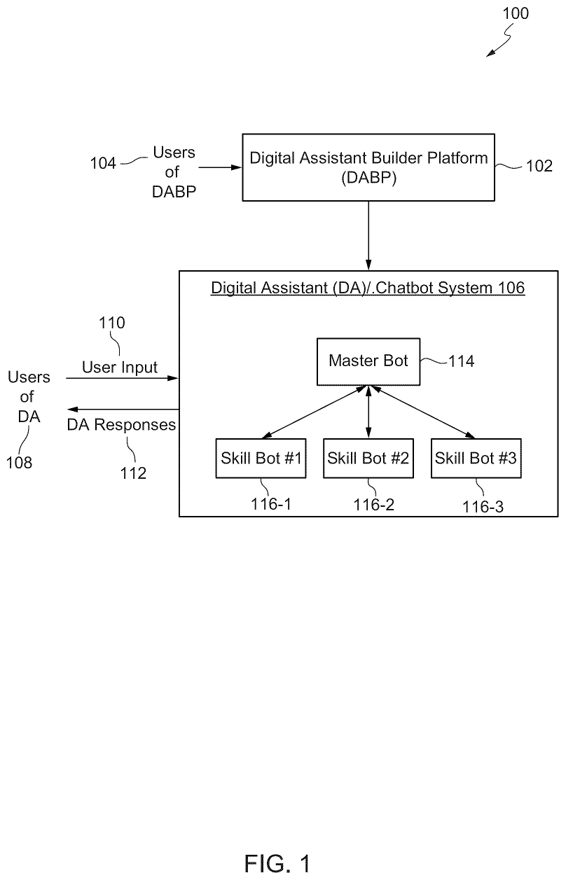

FIG. 1 is a simplified block diagram of an environment 100 incorporating a chatbot system according to certain embodiments. Environment 100 comprises a digital assistant builder platform (DABP) 102 that enables users of DABP 102 to create and deploy digital assistants or chatbot systems. DABP 102 can be used to create one or more digital assistants (or DAs) or chatbot systems. For example, as shown in FIG. 1, user 104 representing a particular enterprise can use DABP 102 to create and deploy a digital assistant 106 for users of the particular enterprise. For example, DABP 102 can be used by a bank to create one or more digital assistants for use by the bank's customers. The same DABP 102 platform can be used by multiple enterprises to create digital assistants. As another example, an owner of a restaurant (e.g., a pizza shop) may use DABP 102 to create and deploy a digital assistant that enables customers of the restaurant to order food (e.g., order pizza).

For purposes of this disclosure, a “digital assistant” is an entity that helps users of the digital assistant accomplish various tasks through natural language conversations. A digital assistant can be implemented using software only (e.g., the digital assistant is a digital entity implemented using programs, code, or instructions executable by one or more processors), using hardware, or using a combination of hardware and software. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

A digital assistant, such as digital assistant 106 built using DABP 102, can be used to perform various tasks via natural language-based conversations between the digital assistant and its users 108. As part of a conversation, a user may provide one or more user inputs 110 to digital assistant 106 and get responses 112 back from digital assistant 106. A conversation can include one or more of inputs 110 and responses 112. Via these conversations, a user can request one or more tasks to be performed by the digital assistant and, in response, the digital assistant is configured to perform the user-requested tasks and respond with appropriate responses to the user.

User inputs 110 are generally in a natural language form and are referred to as utterances. A user utterance 110 can be in text form, such as when a user types in a sentence, a question, a text fragment, or even a single word and provides it as input to digital assistant 106. In some embodiments, a user utterance 110 can be in audio input or speech form, such as when a user says or speaks something that is provided as input to digital assistant 106. The utterances are typically in a language spoken by the user 108. For example, the utterances may be in English, or some other language. When an utterance is in speech form, the speech input is converted to text form utterances in that particular language and the text utterances are then processed by digital assistant 106. Various speech-to-text processing techniques may be used to convert a speech or audio input to a text utterance, which is then processed by digital assistant 106. In some embodiments, the speech-to-text conversion may be done by digital assistant 106 itself.

An utterance, which may be a text utterance or a speech utterance, can be a fragment, a sentence, multiple sentences, one or more words, one or more questions, combinations of the aforementioned types, and the like. Digital assistant 106 is configured to apply natural language understanding (NLU) techniques to the utterance to understand the meaning of the user input. As part of the NLU processing for an utterance, digital assistant 106 is configured to perform processing to understand the meaning of the utterance, which involves identifying one or more intents and one or more entities corresponding to the utterance. Upon understanding the meaning of an utterance, digital assistant 106 may perform one or more actions or operations responsive to the understood meaning or intents. For purposes of this disclosure, it is assumed that the utterances are text utterances that have been provided directly by a user 108 of digital assistant 106 or are the results of conversion of input speech utterances to text form. This however is not intended to be limiting or restrictive in any manner.

For example, a user 108 input may request a pizza to be ordered by providing an utterance such as “I want to order a pizza.” Upon receiving such an utterance, digital assistant 106 is configured to understand the meaning of the utterance and take appropriate actions. The appropriate actions may involve, for example, responding to the user with questions requesting user input on the type of pizza the user desires to order, the size of the pizza, any toppings for the pizza, and the like. The responses provided by digital assistant 106 may also be in natural language form and typically in the same language as the input utterance. As part of generating these responses, digital assistant 106 may perform natural language generation (NLG). For the user ordering a pizza, via the conversation between the user and digital assistant 106, the digital assistant may guide the user to provide all the requisite information for the pizza order, and then at the end of the conversation cause the pizza to be ordered. Digital assistant 106 may end the conversation by outputting information to the user indicating that the pizza has been ordered.

At a conceptual level, digital assistant 106 performs various processing in response to an utterance received from a user. In some embodiments, this processing involves a series or pipeline of processing steps including, for example, understanding the meaning of the input utterance (sometimes referred to as Natural Language Understanding (NLU), determining an action to be performed in response to the utterance, where appropriate causing the action to be performed, generating a response to be output to the user responsive to the user utterance, outputting the response to the user, and the like. The NLU processing can include parsing the received input utterance to understand the structure and meaning of the utterance, refining and reforming the utterance to develop a better understandable form (e.g., logical form) or structure for the utterance. Generating a response may include using NLG techniques.

The NLU processing performed by a digital assistant, such as digital assistant 106, can include various NLP related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain embodiments, the NLU processing or portions thereof is performed by digital assistant 106 itself. In some other embodiments, digital assistant 106 may use other resources to perform portions of the NLU processing. For example, the syntax and structure of an input utterance sentence may be identified by processing the sentence using a parser, a part-of-speech tagger, and/or a named entity recognizer. In one implementation, for the English language, a parser, a part-of-speech tagger, and a named entity recognizer such as ones provided by the Stanford Natural Language Processing (NLP) Group are used for analyzing the sentence structure and syntax. These are provided as part of the Stanford CoreNLP toolkit.

While the various examples provided in this disclosure show utterances in the English language, this is meant only as an example. In certain embodiments, digital assistant 106 is also capable of handling utterances in languages other than English. Digital assistant 106 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

A digital assistant, such as digital assistant 106 depicted in FIG. 1, can be made available or accessible to its users 108 through a variety of different channels, such as but not limited to, via certain applications, via social media platforms, via various messaging services and applications, and other applications or channels. A single digital assistant can have several channels configured for it so that it can be run on and be accessed by different services simultaneously.

A digital assistant or chatbot system generally contains or is associated with one or more skills. In certain embodiments, these skills are individual chatbots (referred to as skill bots) that are configured to interact with users and fulfill specific types of tasks, such as tracking inventory, submitting timecards, creating expense reports, ordering food, checking a bank account, making reservations, buying a widget, and the like. For example, for the embodiment depicted in FIG. 1, digital assistant or chatbot system 106 includes skills 116-1, 116-2, and so on. For purposes of this disclosure, the terms “skill” and “skills” are used synonymously with the terms “skill bot” and “skill bots,” respectively.

Each skill associated with a digital assistant helps a user of the digital assistant complete a task through a conversation with the user, where the conversation can include a combination of text or audio inputs provided by the user and responses provided by the skill bots. These responses may be in the form of text or audio messages to the user and/or using simple user interface elements (e.g., select lists) that are presented to the user for the user to make selections.

There are various ways in which a skill or skill bot can be associated or added to a digital assistant. In some instances, a skill bot can be developed by an enterprise and then added to a digital assistant using DABP 102. In other instances, a skill bot can be developed and created using DABP 102 and then added to a digital assistant created using DABP 102. In yet other instances, DABP 102 provides an online digital store (referred to as a “skills store”) that offers multiple skills directed to a wide range of tasks. The skills offered through the skills store may also expose various cloud services. In order to add a skill to a digital assistant being generated using DABP 102, a user of DABP 102 can access the skills store via DABP 102, select a desired skill, and indicate that the selected skill is to be added to the digital assistant created using DABP 102. A skill from the skills store can be added to a digital assistant as is or in a modified form (for example, a user of DABP 102 may select and clone a particular skill bot provided by the skills store, make customizations or modifications to the selected skill bot, and then add the modified skill bot to a digital assistant created using DABP 102).

Various different architectures may be used to implement a digital assistant or chatbot system. For example, in certain embodiments, the digital assistants created and deployed using DABP 102 may be implemented using a master bot/child (or sub) bot paradigm or architecture. According to this paradigm, a digital assistant is implemented as a master bot that interacts with one or more child bots that are skill bots. For example, in the embodiment depicted in FIG. 1, digital assistant 106 comprises a master bot 114 and skill bots 116-1, 116-2, etc. that are child bots of master bot 114. In certain embodiments, digital assistant 106 is itself considered to act as the master bot.

A digital assistant implemented according to the master-child bot architecture enables users of the digital assistant to interact with multiple skills through a unified user interface, namely via the master bot. When a user engages with a digital assistant, the user input is received by the master bot. The master bot then performs processing to determine the meaning of the user input utterance. The master bot then determines whether the task requested by the user in the utterance can be handled by the master bot itself, else the master bot selects an appropriate skill bot for handling the user request and routes the conversation to the selected skill bot. This enables a user to converse with the digital assistant through a common single interface and still provide the capability to use several skill bots configured to perform specific tasks. For example, for a digital assistance developed for an enterprise, the master bot of the digital assistant may interface with skill bots with specific functionalities, such as a CRM bot for performing functions related to customer relationship management (CRM), an ERP bot for performing functions related to enterprise resource planning (ERP), an HCM bot for performing functions related to human capital management (HCM), etc. This way the end user or consumer of the digital assistant need only know how to access the digital assistant through the common master bot interface and behind the scenes multiple skill bots are provided for handling the user request.

In certain embodiments, in a master bot/child bots infrastructure, the master bot is configured to be aware of the available list of skill bots. The master bot may have access to metadata that identifies the various available skill bots, and for each skill bot, the capabilities of the skill bot including the tasks that can be performed by the skill bot. Upon receiving a user request in the form of an utterance, the master bot is configured to, from the multiple available skill bots, identify or predict a specific skill bot that can best serve or handle the user request. The master bot then routes the utterance (or a portion of the utterance) to that specific skill bot for further handling. Control thus flows from the master bot to the skill bots. The master bot can support multiple input and output channels. In certain embodiments, routing may be performed with the aid of processing performed by one or more available skill bots. For example, as discussed below, a skill bot can be trained to infer an intent for an utterance and to determine whether the inferred intent matches an intent with which the skill bot is configured. Thus, the routing performed by the master bot can involve the skill bot communicating to the master bot an indication of whether the skill bot has been configured with an intent suitable for handling the utterance.

While the embodiment in FIG. 1 shows digital assistant 106 comprising a master bot 114 and skill bots 116-1, 116-2, and 116-3, this is not intended to be limiting. A digital assistant can include various other components (e.g., other systems and subsystems) that provide the functionalities of the digital assistant. These systems and subsystems may be implemented only in software (e.g., code, instructions stored on a computer-readable medium and executable by one or more processors), in hardware only, or in implementations that use a combination of software and hardware.

DABP 102 provides an infrastructure and various services and features that enable a user of DABP 102 to create a digital assistant including one or more skill bots associated with the digital assistant. In some instances, a skill bot can be created by cloning an existing skill bot, for example, cloning a skill bot provided by the skills store. As previously indicated, DABP 102 provides a skills store or skills catalog that offers multiple skill bots for performing various tasks. A user of DABP 102 can clone a skill bot from the skills store. As needed, modifications or customizations may be made to the cloned skill bot. In some other instances, a user of DABP 102 created a skill bot from scratch using tools and services offered by DABP 102. As previously indicated, the skills store or skills catalog provided by DABP 102 may offer multiple skill bots for performing various tasks.

In certain embodiments, at a high level, creating or customizing a skill bot involves the following steps:
(1) Configuring settings for a new skill bot
(2) Configuring one or more intents for the skill bot
(3) Configuring one or more entities for one or more intents
(4) Training the skill bot
(5) Creating a dialog flow for the skill bot
(6) Adding custom components to the skill bot as needed
(7) Testing and deploying the skill bot
   Each of the above steps is briefly described below.

Configuring settings for a new skill bot—Various settings may be configured for the skill bot. For example, a skill bot designer can specify one or more invocation names for the skill bot being created. These invocation names can then be used by users of a digital assistant to explicitly invoke the skill bot. For example, a user can input an invocation name in the user's utterance to explicitly invoke the corresponding skill bot.

(2) Configuring one or more intents and associated example utterances for the skill bot—The skill bot designer specifies one or more intents (also referred to as bot intents) for a skill bot being created. The skill bot is then trained based upon these specified intents. These intents represent categories or classes that the skill bot is trained to infer for input utterances. Upon receiving an utterance, a trained skill bot infers an intent for the utterance, where the inferred intent is selected from the predefined set of intents used to train the skill bot. The skill bot then takes an appropriate action responsive to an utterance based upon the intent inferred for that utterance. In some instances, the intents for a skill bot represent tasks that the skill bot can perform for users of the digital assistant. Each intent is given an intent identifier or intent name. For example, for a skill bot trained for a bank, the intents specified for the skill bot may include “CheckBalance,” “TransferMoney,” “DepositCheck,” and the like.

For each intent defined for a skill bot, the skill bot designer may also provide one or more example utterances that are representative of and illustrate the intent. These example utterances are meant to represent utterances that a user may input to the skill bot for that intent. For example, for the CheckBalance intent, example utterances may include “What's my savings account balance?”, “How much is in my checking account?”, “How much money do I have in my account,” and the like. Accordingly, various permutations of typical user utterances may be specified as example utterances for an intent.

The intents and their associated example utterances are used as training data to train the skill bot. Various different training techniques may be used. As a result of this training, a predictive model is generated that is configured to take an utterance as input and output an intent inferred for the utterance by the predictive model. In some instances, input utterances are provided to an intent analysis engine, which is configured to use the trained model to predict or infer an intent for the input utterance. The skill bot may then take one or more actions based upon the inferred intent.

(3) Configuring entities for one or more intents of the skill bot—In some instances, additional context may be needed to enable the skill bot to properly respond to a user utterance. For example, there may be situations where a user input utterance resolves to the same intent in a skill bot. For instance, in the above example, utterances “What's my savings account balance?” and “How much is in my checking account?” both resolve to the same CheckBalance intent, but these utterances are different requests asking for different things. To clarify such requests, one or more entities are added to an intent. Using the banking skill bot example, an entity called AccountType, which defines values called “checking” and “saving” may enable the skill bot to parse the user request and respond appropriately. In the above example, while the utterances resolve to the same intent, the value associated with the AccountType entity is different for the two utterances. This enables the skill bot to perform possibly different actions for the two utterances in spite of them resolving to the same intent. One or more entities can be specified for certain intents configured for the skill bot. Entities are thus used to add context to the intent itself. Entities help describe an intent more fully and enable the skill bot to complete a user request.

In certain embodiments, there are two types of entities: (a) built-in entities provided by DABP 102, and (2) custom entities that can be specified by a skill bot designer. Built-in entities are generic entities that can be used with a wide variety of bots. Examples of built-in entities include, without limitation, entities related to time, date, addresses, numbers, email addresses, duration, recurring time periods, currencies, phone numbers, URLs, and the like. Custom entities are used for more customized applications. For example, for a banking skill, an AccountType entity may be defined by the skill bot designer that enables various banking transactions by checking the user input for keywords like checking, savings, and credit cards, etc.

(4) Training the skill bot—A skill bot is configured to receive user input in the form of utterances parse or otherwise process the received input, and identify or select an intent that is relevant to the received user input. As indicated above, the skill bot has to be trained for this. In certain embodiments, a skill bot is trained based upon the intents configured for the skill bot and the example utterances associated with the intents (collectively, the training data), so that the skill bot can resolve user input utterances to one of its configured intents. In certain embodiments, the skill bot uses a predictive model that is trained using the training data and allows the skill bot to discern what users say (or in some cases, are trying to say). DABP 102 provides various different training techniques that can be used by a skill bot designer to train a skill bot, including various machine-learning based training techniques, rules-based training techniques, and/or combinations thereof. In certain embodiments, a portion (e.g., 80%) of the training data is used to train a skill bot model and another portion (e.g., the remaining 20%) is used to test or verify the model. Once trained, the trained model (also sometimes referred to as the trained skill bot) can then be used to handle and respond to user utterances. In certain cases, a user's utterance may be a question that requires only a single answer and no further conversation. In order to handle such situations, a Q&A (question-and-answer) intent may be defined for a skill bot. This enables a skill bot to output replies to user requests without having to update the dialog definition. Q&A intents are created in a similar manner as regular intents. The dialog flow for Q&A intents can be different from that for regular intents.

(5) Creating a dialog flow for the skill bot—A dialog flow specified for a skill bot describes how the skill bot reacts as different intents for the skill bot are resolved responsive to received user input. The dialog flow defines operations or actions that a skill bot will take, e.g., how the skill bot responds to user utterances, how the skill bot prompts users for input, how the skill bot returns data. A dialog flow is like a flowchart that is followed by the skill bot. The skill bot designer specifies a dialog flow using a language, such as markdown language. In certain embodiments, a version of YAML called OBotML may be used to specify a dialog flow for a skill bot. The dialog flow definition for a skill bot acts as a model for the conversation itself, one that lets the skill bot designer choreograph the interactions between a skill bot and the users that the skill bot services.

In certain embodiments, the dialog flow definition for a skill bot contains three sections:
(a) a context section
(b) a default transitions section
(c) a states section

Context section—The skill bot designer can define variables that are used in a conversation flow in the context section. Other variables that may be named in the context section include, without limitation: variables for error handling, variables for built-in or custom entities, user variables that enable the skill bot to recognize and persist user preferences, and the like.

Default transitions section—Transitions for a skill bot can be defined in the dialog flow states section or in the default transitions section. The transitions defined in the default transition section act as a fallback and get triggered when there are no applicable transitions defined within a state, or the conditions required to trigger a state transition cannot be met. The default transitions section can be used to define routing that allows the skill bot to gracefully handle unexpected user actions.

States section—A dialog flow and its related operations are defined as a sequence of transitory states, which manage the logic within the dialog flow. Each state node within a dialog flow definition names a component that provides the functionality needed at that point in the dialog. States are thus built around the components. A state contains component-specific properties and defines the transitions to other states that get triggered after the component executes.

Special case scenarios may be handled using the states sections. For example, there might be times when you want to provide users the option to temporarily leave a first skill they are engaged with to do something in a second skill within the digital assistant. For example, if a user is engaged in a conversation with a shopping skill (e.g., the user has made some selections for purchase), the user may want to jump to a banking skill (e.g., the user may want to ensure that he/she has enough money for the purchase), and then return to the shopping skill to complete the user's order. To address this, an action in the first skill can be configured to initiate an interaction with the second different skill in the same digital assistant and then return to the original flow.

(6) Adding custom components to the skill bot—As described above, states specified in a dialog flow for a skill bot name components that provide the functionality needed corresponding to the states. Components enable a skill bot to perform functions. In certain embodiments, DABP 102 provides a set of preconfigured components for performing a wide range of functions. A skill bot designer can select one of more of these preconfigured components and associate them with states in the dialog flow for a skill bot. The skill bot designer can also create custom or new components using tools provided by DABP 102 and associate the custom components with one or more states in the dialog flow for a skill bot.

(7) Testing and deploying the skill bot—DABP 102 provides several features that enable the skill bot designer to test a skill bot being developed. The skill bot can then be deployed and included in a digital assistant.

While the description above describes how to create a skill bot, similar techniques may also be used to create a digital assistant (or the master bot). At the master bot or digital assistant level, built-in system intents may be configured for the digital assistant. These built-in system intents are used to identify general tasks that the digital assistant itself (i.e., the master bot) can handle without invoking a skill bot associated with the digital assistant. Examples of system intents defined for a master bot include: (1) Exit: applies when the user signals the desire to exit the current conversation or context in the digital assistant; (2) Help: applies when the user asks for help or orientation; and (3) UnresolvedIntent: applies to user input that doesn't match well with the exit and help intents. The digital assistant also stores information about the one or more skill bots associated with the digital assistant. This information enables the master bot to select a particular skill bot for handling an utterance.

At the master bot or digital assistant level, when a user inputs a phrase or utterance to the digital assistant, the digital assistant is configured to perform processing to determine how to route the utterance and the related conversation. The digital assistant determines this using a routing model, which can be rules-based, AI-based, or a combination thereof. The digital assistant uses the routing model to determine whether the conversation corresponding to the user input utterance is to be routed to a particular skill for handling, is to be handled by the digital assistant or master bot itself per a built-in system intent, or is to be handled as a different state in a current conversation flow.

In certain embodiments, as part of this processing, the digital assistant determines if the user input utterance explicitly identifies a skill bot using its invocation name. If an invocation name is present in the user input, then it is treated as explicit invocation of the skill bot corresponding to the invocation name. In such a scenario, the digital assistant may route the user input to the explicitly invoked skill bot for further handling. If there is no specific or explicit invocation, in certain embodiments, the digital assistant evaluates the received user input utterance and computes confidence scores for the system intents and the skill bots associated with the digital assistant. The score computed for a skill bot or system intent represents how likely the user input is representative of a task that the skill bot is configured to perform or is representative of a system intent. Any system intent or skill bot with an associated computed confidence score exceeding a threshold value (e.g., a Confidence Threshold routing parameter) is selected as a candidate for further evaluation. The digital assistant then selects, from the identified candidates, a particular system intent or a skill bot for further handling of the user input utterance. In certain embodiments, after one or more skill bots are identified as candidates, the intents associated with those candidate skills are evaluated (according to the intent model for each skill) and confidence scores are determined for each intent. In general, any intent that has a confidence score exceeding a threshold value (e.g., 70%) is treated as a candidate intent. If a particular skill bot is selected, then the user utterance is routed to that skill bot for further processing. If a system intent is selected, then one or more actions are performed by the master bot itself according to the selected system intent.

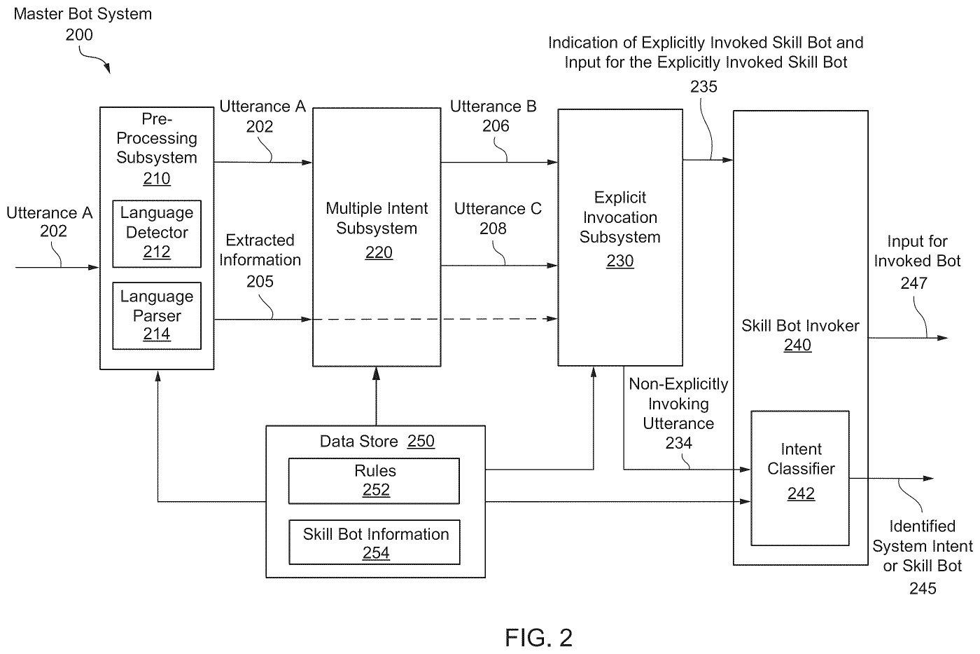

FIG. 2 is a simplified block diagram of a master bot (MB) system 200 according to certain embodiments. MB system 200 can be implemented in software only, hardware only, or a combination of hardware and software. MB system 200 includes a pre-processing subsystem 210, a multiple intent subsystem (MIS) 220, an explicit invocation subsystem (EIS) 230, a skill bot invoker 240, and a data store 250. MB system 200 depicted in FIG. 2 is merely an example of an arrangement of components in a master bot. One of ordinary skill in the art would recognize many possible variations, alternatives, and modifications. For example, in some implementations, MB system 200 may have more or fewer systems or components than those shown in FIG. 2, may combine two or more subsystems, or may have a different configuration or arrangement of subsystems.

Pre-processing subsystem 210 receives an utterance “A” 202 from a user and processes the utterance through a language detector 212 and a language parser 214. As indicated above, an utterance can be provided in various ways including audio or text. The utterance 202 can be a sentence fragment, a complete sentence, multiple sentences, and the like. Utterance 202 can include punctuation. For example, if the utterance 202 is provided as audio, the pre-processing subsystem 210 may convert the audio to text using a speech-to-text converter (not shown) that inserts punctuation marks into the resulting text, e.g., commas, semicolons, periods, etc.

Language detector 212 detects the language of the utterance 202 based on the text of the utterance 202. The manner in which the utterance 202 is handled depends on the language since each language has its own grammar and semantics. Differences between languages are taken into consideration when analyzing the syntax and structure of an utterance.

Language parser 214 parses the utterance 202 to extract part of speech (POS) tags for individual linguistic units (e.g., words) in the utterance 202. POS tags include, for example, noun (NN), pronoun (PN), verb (VB), and the like. Language parser 214 may also tokenize the linguistic units of the utterance 202 (e.g., to convert each word into a separate token) and lemmatize words. A lemma is the main form of a set of words as represented in a dictionary (e.g., “run” is the lemma for run, runs, ran, running, etc.). Other types of pre-processing that the language parser 214 can perform include chunking of compound expressions, e.g., combining “credit” and “card” into a single expression “credit_card.” Language parser 214 may also identify relationships between the words in the utterance 202. For example, in some embodiments, the language parser 214 generates a dependency tree that indicates which part of the utterance (e.g., a particular noun) is a direct object, which part of the utterance is a preposition, and so on. The results of the processing performed by the language parser 214 form extracted information 205 and are provided as input to MIS 220 together with the utterance 202 itself.

As indicated above, the utterance 202 can include more than one sentence. For purposes of detecting multiple intents and explicit invocation, the utterance 202 can be treated as a single unit even if it includes multiple sentences. However, in certain embodiments, pre-processing can be performed, e.g., by the pre-processing subsystem 210, to identify a single sentence among multiple sentences for multiple intents analysis and explicit invocation analysis. In general, the results produced by MIS 220 and EIS 230 are substantially the same regardless of whether the utterance 202 is processed at the level of an individual sentence or as a single unit comprising multiple sentences.

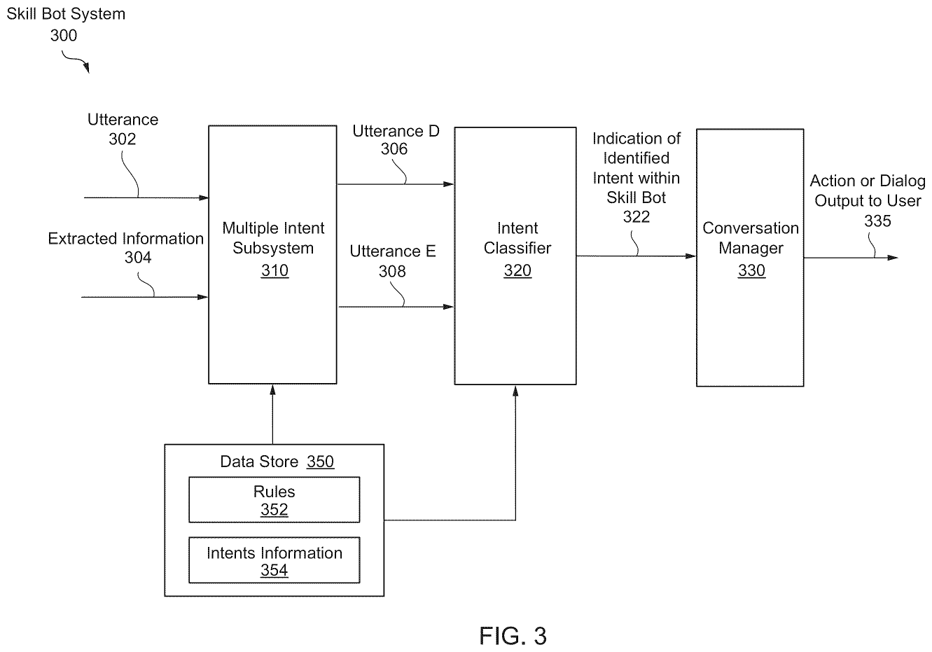

MIS 220 determines whether the utterance 202 represents multiple intents. Although MIS 220 can detect the presence of multiple intents in the utterance 202, the processing performed by MIS 220 does not involve determining whether the intents of the utterance 202 match to any intents that have been configured for a bot. Instead, processing to determine whether an intent of the utterance 202 matches a bot intent can be performed by an intent classifier 242 of the MB system 200 or by an intent classifier of a skill bot (e.g., as shown in the embodiment of FIG. 3). The processing performed by MIS 220 assumes that there exists a bot (e.g., a particular skill bot or the master bot itself) that can handle the utterance 202. Therefore, the processing performed by MIS 220 does not require knowledge of what bots are in the chatbot system (e.g., the identities of skill bots registered with the master bot), or knowledge of what intents have been configured for a particular bot.

To determine that the utterance 202 includes multiple intents, the MIS 220 applies one or more rules from a set of rules 252 in the data store 250. The rules applied to the utterance 202 depend on the language of the utterance 202 and may include sentence patterns that indicate the presence of multiple intents. For example, a sentence pattern may include a coordinating conjunction that joins two parts (e.g., conjuncts) of a sentence, where both parts correspond to a separate intent. If the utterance 202 matches the sentence pattern, it can be inferred that the utterance 202 represents multiple intents. It should be noted that an utterance with multiple intents does not necessarily have different intents (e.g., intents directed to different bots or to different intents within the same bot). Instead, the utterance could have separate instances of the same intent, e.g., “Place a pizza order using payment account X, then place a pizza order using payment account Y.”

As part of determining that the utterance 202 represents multiple intents, the MIS 220 also determines what portions of the utterance 202 are associated with each intent. MIS 220 constructs, for each intent represented in an utterance containing multiple intents, a new utterance for separate processing in place of the original utterance, e.g., an utterance “B” 206 and an utterance “C” 208, as depicted in FIG. 2. Thus, the original utterance 202 can be split into two or more separate utterances that are handled one at a time. MIS 220 determines, using the extracted information 205 and/or from analysis of the utterance 202 itself, which of the two or more utterances should be handled first. For example, MIS 220 may determine that the utterance 202 contains a marker word indicating that a particular intent should be handled first. The newly formed utterance corresponding to this particular intent (e.g., one of utterance 206 or utterance 208) will be the first to be sent for further processing by EIS 230. After a conversation triggered by the first utterance has ended (or has been temporarily suspended), the next highest priority utterance (e.g., the other one of utterance 206 or utterance 208) can then be sent to the EIS 230 for processing.

EIS 230 determines whether the utterance that it receives (e.g., utterance 206 or utterance 208) contains an invocation name of a skill bot. In certain embodiments, each skill bot in a chatbot system is assigned a unique invocation name that distinguishes the skill bot from other skill bots in the chatbot system. A list of invocation names can be maintained as part of skill bot information 254 in data store 250. An utterance is deemed to be an explicit invocation when the utterance contains a word match to an invocation name. If a bot is not explicitly invoked, then the utterance received by the EIS 230 is deemed a non-explicitly invoking utterance 234 and is input to an intent classifier (e.g., intent classifier 242) of the master bot to determine which bot to use for handling the utterance. In some instances, the intent classifier 242 will determine that the master bot should handle a non-explicitly invoking utterance. In other instances, the intent classifier 242 will determine a skill bot to route the utterance to for handling.

The explicit invocation functionality provided by the EIS 230 has several advantages. It can reduce the amount of processing that the master bot has to perform. For example, when there is an explicit invocation, the master bot may not have to do any intent classification analysis (e.g., using the intent classifier 242), or may have to do reduced intent classification analysis for selecting a skill bot. Thus, explicit invocation analysis may enable selection of a particular skill bot without resorting to intent classification analysis.

Also, there may be situations where there is an overlap in functionalities between multiple skill bots. This may happen, for example, if the intents handled by the two skill bots overlap or are very close to each other. In such a situation, it may be difficult for the master bot to identify which of the multiple skill bots to select based upon intent classification analysis alone. In such scenarios, the explicit invocation disambiguates the particular skill bot to be used.

In addition to determining that an utterance is an explicit invocation, the EIS 230 is responsible for determining whether any portion of the utterance should be used as input to the skill bot being explicitly invoked. In particular, EIS 230 can determine whether part of the utterance is not associated with the invocation. The EIS 230 can perform this determination through analysis of the utterance and/or analysis of the extracted information 205. EIS 230 can send the part of the utterance not associated with the invocation to the invoked skill bot in lieu of sending the entire utterance that was received by the EIS 230. In some instances, the input to the invoked skill bot is formed simply by removing any portion of the utterance associated with the invocation. For example, “I want to order pizza using Pizza Bot” can be shortened to “I want to order pizza” since “using Pizza Bot” is relevant to the invocation of the pizza bot, but irrelevant to any processing to be performed by the pizza bot. In some instances, EIS 230 may reformat the part to be sent to the invoked bot, e.g., to form a complete sentence. Thus, the EIS 230 determines not only that there is an explicit invocation, but also what to send to the skill bot when there is an explicit invocation. In some instances, there may not be any text to input to the bot being invoked. For example, if the utterance was “Pizza Bot”, then the EIS 230 could determine that the pizza bot is being invoked, but there is no text to be processed by the pizza bot. In such scenarios, the EIS 230 may indicate to the skill bot invoker 240 that there is nothing to send.

Skill bot invoker 240 invokes a skill bot in various ways. For instance, skill bot invoker 240 can invoke a bot in response to receiving an indication 235 that a particular skill bot has been selected as a result of an explicit invocation. The indication 235 can be sent by the EIS 230 together with the input for the explicitly invoked skill bot. In this scenario, the skill bot invoker 240 will turn control of the conversation over to the explicitly invoked skill bot. The explicitly invoked skill bot will determine an appropriate response to the input from the EIS 230 by treating the input as a stand-alone utterance. For example, the response could be to perform a specific action or to start a new conversation in a particular state, where the initial state of the new conversation depends on the input sent from the EIS 230.

Another way in which skill bot invoker 240 can invoke a skill bot is through implicit invocation using the intent classifier 242. The intent classifier 242 can be trained, using machine-learning and/or rules-based training techniques, to determine a likelihood that an utterance is representative of a task that a particular skill bot is configured to perform. The intent classifier 242 is trained on different classes, one class for each skill bot. For instance, whenever a new skill bot is registered with the master bot, a list of example utterances associated with the new skill bot can be used to train the intent classifier 242 to determine a likelihood that a particular utterance is representative of a task that the new skill bot can perform. The parameters produced as result of this training (e.g., a set of values for parameters of a machine-learning model) can be stored as part of skill bot information 254.

In certain embodiments, the intent classifier 242 is implemented using a machine-learning model, as described in further detail herein. Training of the machine-learning model may involve inputting at least a subset of utterances from the example utterances associated with various skill bots to generate, as an output of the machine-learning model, inferences as to which bot is the correct bot for handling any particular training utterance. For each training utterance, an indication of the correct bot to use for the training utterance may be provided as ground truth information. The behavior of the machine-learning model can then be adapted (e.g., through back-propagation) to minimize the difference between the generated inferences and the ground truth information.

In certain embodiments, the intent classifier 242 determines, for each skill bot registered with the master bot, a confidence score indicating a likelihood that the skill bot can handle an utterance (e.g., the non-explicitly invoking utterance 234 received from EIS 230). The intent classifier 242 may also determine a confidence score for each system level intent (e.g., help, exit) that has been configured. If a particular confidence score meets one or more conditions, then the skill bot invoker 240 will invoke the bot associated with the particular confidence score. For example, a threshold confidence score value may need to be met. Thus, an output 245 of the intent classifier 242 is either an identification of a system intent or an identification of a particular skill bot. In some embodiments, in addition to meeting a threshold confidence score value, the confidence score must exceed the next highest confidence score by a certain win margin. Imposing such a condition would enable routing to a particular skill bot when the confidence scores of multiple skill bots each exceed the threshold confidence score value.

After identifying a bot based on evaluation of confidence scores, the skill bot invoker 240 hands over processing to the identified bot. In the case of a system intent, the identified bot is the master bot. Otherwise, the identified bot is a skill bot. Further, the skill bot invoker 240 will determine what to provide as input 247 for the identified bot. As indicated above, in the case of an explicit invocation, the input 247 can be based on a part of an utterance that is not associated with the invocation, or the input 247 can be nothing (e.g., an empty string). In the case of an implicit invocation, the input 247 can be the entire utterance.

Data store 250 comprises one or more computing devices that store data used by the various subsystems of the master bot system 200. As explained above, the data store 250 includes rules 252 and skill bot information 254. The rules 252 include, for example, rules for determining, by MIS 220, when an utterance represents multiple intents and how to split an utterance that represents multiple intents. The rules 252 further include rules for determining, by EIS 230, which parts of an utterance that explicitly invokes a skill bot to send to the skill bot. The skill bot information 254 includes invocation names of skill bots in the chatbot system, e.g., a list of the invocation names of all skill bots registered with a particular master bot. The skill bot information 254 can also include information used by intent classifier 242 to determine a confidence score for each skill bot in the chatbot system, e.g., parameters of a machine-learning model.

FIG. 3 is a simplified block diagram of a skill bot system 300 according to certain embodiments. Skill bot system 300 is a computing system that can be implemented in software only, hardware only, or a combination of hardware and software. In certain embodiments such as the embodiment depicted in FIG. 1, skill bot system 300 can be used to implement one or more skill bots within a digital assistant.

Skill bot system 300 includes an MIS 310, an intent classifier 320, and a conversation manager 330. The MIS 310 is analogous to the MIS 220 in FIG. 2 and provides similar functionality, including being operable to determine, using rules 352 in a data store 350: (1) whether an utterance represents multiple intents and, if so, (2) how to split the utterance into a separate utterance for each intent of the multiple intents. In certain embodiments, the rules applied by MIS 310 for detecting multiple intents and for splitting an utterance are the same as those applied by MIS 220. The MIS 310 receives an utterance 302 and extracted information 304. The extracted information 304 is analogous to the extracted information 205 in FIG. 1 and can be generated using the language parser 214 or a language parser local to the skill bot system 300.

Intent classifier 320 can be trained in a similar manner to the intent classifier 242 discussed above in connection with the embodiment of FIG. 2 and as described in further detail herein. For instance, in certain embodiments, the intent classifier 320 is implemented using a machine-learning model. The machine-learning model of the intent classifier 320 is trained for a particular skill bot, using at least a subset of example utterances associated with that particular skill bot as training utterances. The ground truth for each training utterance would be the particular bot intent associated with the training utterance.

The utterance 302 can be received directly from the user or supplied through a master bot. When the utterance 302 is supplied through a master bot, e.g., as a result of processing through MIS 220 and EIS 230 in the embodiment depicted in FIG. 2, the MIS 310 can be bypassed so as to avoid repeating processing already performed by MIS 220. However, if the utterance 302 is received directly from the user, e.g., during a conversation that occurs after routing to a skill bot, then MIS 310 can process the utterance 302 to determine whether the utterance 302 represents multiple intents. If so, then MIS 310 applies one or more rules to split the utterance 302 into a separate utterance for each intent, e.g., an utterance “D” 306 and an utterance “E” 308. If utterance 302 does not represent multiple intents, then MIS 310 forwards the utterance 302 to intent classifier 320 for intent classification and without splitting the utterance 302.

Intent classifier 320 is configured to match a received utterance (e.g., utterance 306 or 308) to an intent associated with skill bot system 300. As explained above, a skill bot can be configured with one or more intents, each intent including at least one example utterance that is associated with the intent and used for training a classifier. In the embodiment of FIG. 2, the intent classifier 242 of the master bot system 200 is trained to determine confidence scores for individual skill bots and confidence scores for system intents. Similarly, intent classifier 320 can be trained to determine a confidence score for each intent associated with the skill bot system 300. Whereas the classification performed by intent classifier 242 is at the bot level, the classification performed by intent classifier 320 is at the intent level and therefore finer grained. The intent classifier 320 has access to intents information 354. The intents information 354 includes, for each intent associated with the skill bot system 300, a list of utterances that are representative of and illustrate the meaning of the intent and are typically associated with a task performable by that intent. The intents information 354 can further include parameters produced as a result of training on this list of utterances.

Conversation manager 330 receives, as an output of intent classifier 320, an indication 322 of a particular intent, identified by the intent classifier 320, as best matching the utterance that was input to the intent classifier 320. In some instances, the intent classifier 320 is unable to determine any match. For example, the confidence scores computed by the intent classifier 320 could fall below a threshold confidence score value if the utterance is directed to a system intent or an intent of a different skill bot. When this occurs, the skill bot system 300 may refer the utterance to the master bot for handling, e.g., to route to a different skill bot. However, if the intent classifier 320 is successful in identifying an intent within the skill bot, then the conversation manager 330 will initiate a conversation with the user.

The conversation initiated by the conversation manager 330 is a conversation specific to the intent identified by the intent classifier 320. For instance, the conversation manager 330 may be implemented using a state machine configured to execute a dialog flow for the identified intent. The state machine can include a default starting state (e.g., for when the intent is invoked without any additional input) and one or more additional states, where each state has associated with it actions to be performed by the skill bot (e.g., executing a purchase transaction) and/or dialog (e.g., questions, responses) to be presented to the user. Thus, the conversation manager 330 can determine an action/dialog 335 upon receiving the indication 322 identifying the intent and can determine additional actions or dialog in response to subsequent utterances received during the conversation.

Data store 350 comprises one or more computing devices that store data used by the various subsystems of the skill bot system 300. As depicted in FIG. 3, the data store 350 includes the rules 352 and the intents information 354. In certain embodiments, data store 350 can be integrated into a data store of a master bot or digital assistant, e.g., the data store 250 in FIG. 2.

### III. Converting a Natural Language Utterance to a Logical Form Query

In some aspects, a model is trained to generate, based on a natural language utterance, a logical form that is an intermediate query representation. This intermediate query representation can then be translated into a suitable back-end system language such as SQL, PGQL, OAC API, etc. In some instances, the intermediate representation is in a language called Oracle Meaning Representation Language (OMRL), and a Conversation to Oracle Meaning Representation Language (C20MRL) system performs the conversion of the natural language utterance to the logical form. The C20MRL system is powered by a deep learning model configured to convert a natural language (NL) utterance (or a conversation within the Oracle Digital Assistant platform) into a logical form in an intermediate query language such as Oracle Meaning Representation Language (OMRL). The logical form can be used to generate a query or command in a specific back-end system language, which can then be executed for querying or controlling the back-end system, e.g., an existing database or OAC. This deep learning model (referred to as a “C20MRL semantic parser” or “C20MRL model”) is trained with thousands of example pairs (natural language to logical form).

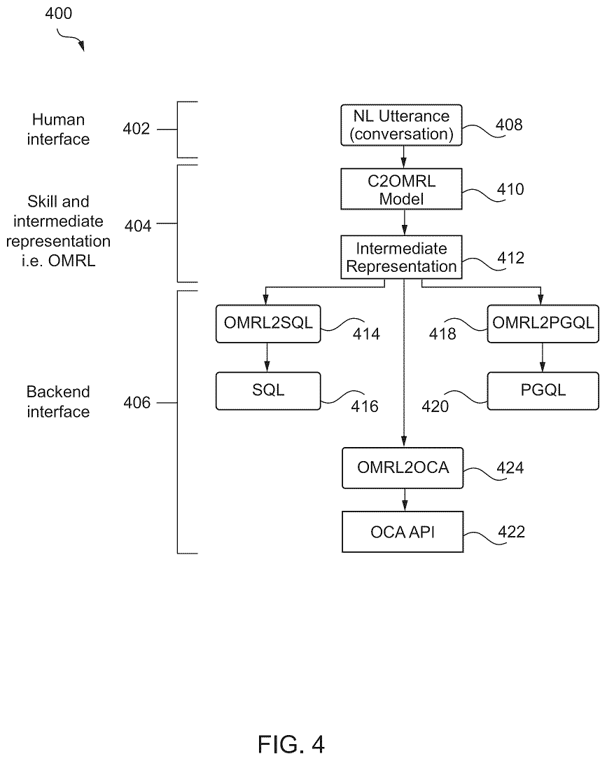

FIG. 4 is a block diagram 400 illustrating an overview of a C20MRL architecture and process for generating a query or command for a backend interface 406 starting with a NL utterance 408, e.g., as received via a human interface 402. For example, the human interface 402 can be a chatbot system that receives spoken speech and translates it to a text utterance, as described above, or a system where a user types in a request in natural language, or other suitable interfaces. The NL utterance 408 can be in the form of part of a conversation (e.g., “Hello, can you tell me how many orders we need to send out tomorrow?” or “Search for all employees with first name starting with ‘S’ and living in California.”).

The NL utterance 408 is provided to a NL2LF model 410, which converts the NL utterance 408 to an intermediate representation 412 (e.g., MRL or OMRL). The NL2LF model 410 is a machine learning model trained to generate intermediate representations 412 from NL utterances 408. The NL2LF model 410 includes multiple layers and algorithms for generating intermediate representations 412 from NL utterances 408, as described herein in further detail. In some instances, as depicted in FIG. 4, the NL2LF model 410 is a C20MRL model for converting a conversational utterance to OMRL 412. The NL2LF model 410 may be described interchangeably herein with C20MRL, although it should be understood that the techniques described herein can be applied to models configured to generate other intermediate representation 412 formats. The intermediate representation 412 is a logical representation of the utterance, which is configured to be translatable into a specific system query language. In some examples, the intermediate representation 412 is OMRL, an intermediate database query language with a specialized schema and interface specification. The intermediate representation 412 may be described interchangeably herein with OMRL, although it should be understood that the techniques described herein can be applied to other intermediate representation 412 formats.

The intermediate representation 412 can then be translated to one or more desired back-end system languages, such as SQL 416, PGQL 420, or OAC API 422, using one or more system language translation processes, such as an OMRL2SQL 414 translation process, a OMRL2PGQL 418 translation process, or a OMRL20AC 424 translation process. The translated query or command (e.g., SQL 416, PGQL 420, or OAC API 422) represents the concepts that are present in intermediate representation 412 in a manner that conforms to the requirements of the applicable system language.

### IV. Overview of System for Translating Natural Language to Meaning Representation Language

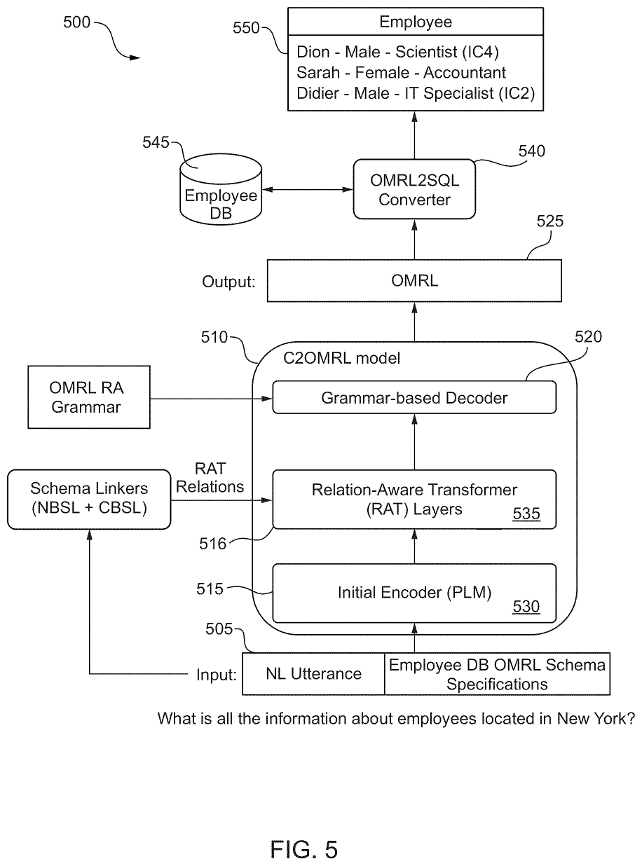

FIG. 5 shows a C20MRL system 500 powered by a machine learning model to be able to convert a NL utterance (e.g., an utterance within the Digital Assistant platform as described with respect to FIGS. 1-3) into a LF statement such as OMRL query or command, which in turn can be executed for querying an existing system such as a relational database or analytics platform such as OAC. This machine learning model (referred to herein as the “C20MRL semantic parser” or “C20MRL model” or simply “parser”) is trained on hundreds to thousands of annotated example pairs (natural language and logical form pairs) for translating NL utterance into a LF statement. As shown, an example 505 (concatenation of a natural language utterance and one or more schema, e.g., a database schema including a sequence of table and column names) is input into the C20MRL model 510. The example 505 is first processed by the encoder component 515, which captures the representation of the natural language utterance and the schema contextually. The decoder 520 then receives the encoded input and predicts the logical form 525 (e.g., OMRL, which is a SQL-like query) based on the captured representation of the natural language utterance and the schema.

In the C20MRL model 510, the encoder component 515 includes two encoders (1) a first encoder, which is a Pre-trained Language Model (PLM) 530; and (2) a second encoder, which is a Relation-Aware Transformer (RAT) 535. The PLM 530 is used to embed the natural language utterance and schema, as it captures a representation of the natural language utterance and the schema contextually. In certain instances, a transformer-based PLM called Decoding-enhanced BERT with disentangled attention (DeBERTa) is used as the PLM 530. (See He et al., DeBERTaV3: Improving DeBERTa using ELECTRA-Style Pre-Training with Gradient-Disentangled Embedding Sharing (2021), the entire contents of which are incorporated herein by reference for all purposes). Transformer-based PLMs learn universal language representations from large volumes of text data using self-supervised learning and transfer this knowledge to downstream tasks. These models provide good background knowledge to downstream tasks which avoids training of downstream models from scratch. The RAT 535 encodes the relations between entities in the schema and words in the natural language utterance (these relations are called “schema linking” relations).

The decoder 520 is based on a bottom-up generative process (i.e., the bottom-up generative process generates a tree from left to right), where the final generation output is a OMRL tree (i.e., a tree-based structure that represents the full OMRL logical form) that can be mapped to a final OMRL logical form 525. The bottom-up generative process is implemented using a beam search, which is a heuristic search algorithm that explores a graph by expanding the most promising node in a limited set. The beam search works in steps (e.g., ˜10 steps), also called “beam levels”. At each step (e.g., “step i”), the beam search algorithm generates a number l′ of possible sub-trees for an input sequence that can be obtained by extending the current sub-trees (from step “i-1”), and then selects the top-K sub-trees (known as beam width) for retention using the conditional probability associated with each sub-tree. The conditional probability is referred to herein as a “raw beam score”, and thus the top-K intermediate results (to be considered in the next generative step) are the K ones with the highest raw beam scores. Additional information for the bottom-up generative process is found in “Ohad Rubin and Jonathan Berant. 2021. SmBoP: Semi-autoregressive Bottom-up Semantic Parsing, in Proceedings of the 2021 Conference of the North American Chapter of the Association for Computational Linguistics: Human Language Technologies, pages 311-324, Online. Association for Computational Linguistics,” the entire contents of which are incorporated herein by reference for all purposes. The final decoder 520 output is the sub-tree with the highest raw beam score at the last step N.

For example, at a first step (beam level 1), the encoded input utterance and schema are input to the decoder 520 and the decoder 520 will apply a softmax function to all the tokens in a vocabulary or grammar to find the best alternatives for a first sub-tree (e.g., a first token or node of a tree). To generate the number F of possible sub-trees (known as the frontier), the decoder 520 makes predictions representing the conditional probability of each token in the vocabulary or grammar coming next in a sequence (the likely value of yi+1, conditioned on the previous tokens y1, . . . , yi and the context variable c, produced by the encoder to represent the input sequence). The vocabulary or grammar is obtained from a corpus comprising words or terms in the target logical form (e.g., OMRL). In certain instances, the corpus further comprises rules for the words or terms in the target logical form. The rules define how the words or terms may be used to create a proper phrase or operation in the target logical form (e.g., the combination of terms that work together for a proper OMRL query). The beam search algorithm then selects the top-K sub-trees with the highest conditional probability or raw beam score as the most likely possible choices for the time step. In this example, suppose the top-K sub-trees or beam width is 2 and that the sub-trees with the highest conditional probabilities P (y1|c) in the first step are sub-tree_1 and sub-tree_12. The top-K results can be a selectable and/or optimizable hyperparameter. Sub-tree_1 and sub-tree_12 and the corresponding conditional probabilities or raw beam scores are saved in memory.

At a second step (beam level 2), the two selected trees (sub-tree_1 and sub-tree_12) from the first step are input to the decoder 520 and the decoder 520 will apply the softmax function to all the tokens in the vocabulary or grammar to find the two best alternatives for the second sub-tree (e.g., a first and second token or node of a tree). While doing this, the beam search algorithm will determine the combination of the first and second tokens or nodes that are most likely to form a pair or second sub-tree using the conditional probabilities. In other words, for all y2€Y, the beam search algorithm computes P(sub-tree_1,y2|c)=P(sub-tree_1|c) P (y2|sub-tree_1,c), P(sub-tree_12,y2|c)=P(sub-tree_12|c) P (y2|sub-tree_12,c), and select the largest two among these values, for example P(sub-tree_22|c) and P(sub-tree_37|c). Sub-tree_22 and sub-tree_37 and the corresponding conditional probabilities or raw beam scores are saved in memory.

At a third step (beam level 3), the two selected trees (sub-tree_22 and sub-tree_37) from the second step are input to the decoder 520 and the decoder 520 will apply the softmax function to all the tokens in the vocabulary or grammar to find the two best alternatives for the third sub-tree (e.g., a first, second, and third token or node of a tree). While doing this, the beam search algorithm will determine the combination of the first, second, and third tokens or nodes that are most likely to form a string or third sub-tree using the conditional probabilities. In other words, for all y3∈Y, the beam search algorithm computes P(sub-tree_22,y3|c)=P(sub-tree_22|c) P (y3|sub-tree_22,c), P(sub-tree_37,y3|c)=P(sub-tree_37|c) P (y3|sub-tree_37,c), and select the top-K sub-trees. The top-K sub-trees and the corresponding conditional probabilities or raw beam scores are saved in memory. This process continues until N number of beam levels is completed (this could be an optimized or selected hyperparameter). The final model output is the sub-tree with the highest conditional probability or raw beam score at the last step N (beam level N). The tokens or nodes of this final sub-tree can then be mapped to a final logical form such as OMRL logical form statement 525.

The MRL logical form statement 525 (e.g., the OMRL tree with the highest raw beam score at the last step N) can then be input into a language converter 540 such as (OMRL2SQL or OMRL20AC) to translate the meaning representation language to a systems language query or command such as SQL, APIs, REST, GraphQL, PGQL, OAC API, etc. The systems language query or command can then be used to query or execute an operation on a system 545 (e.g., a relational database or analytics platform) and obtain an output 550 as a result of the query or command.

### V. Techniques for Manufacturing Training Data to Transform Natural Language Conversation into Visualization Representations

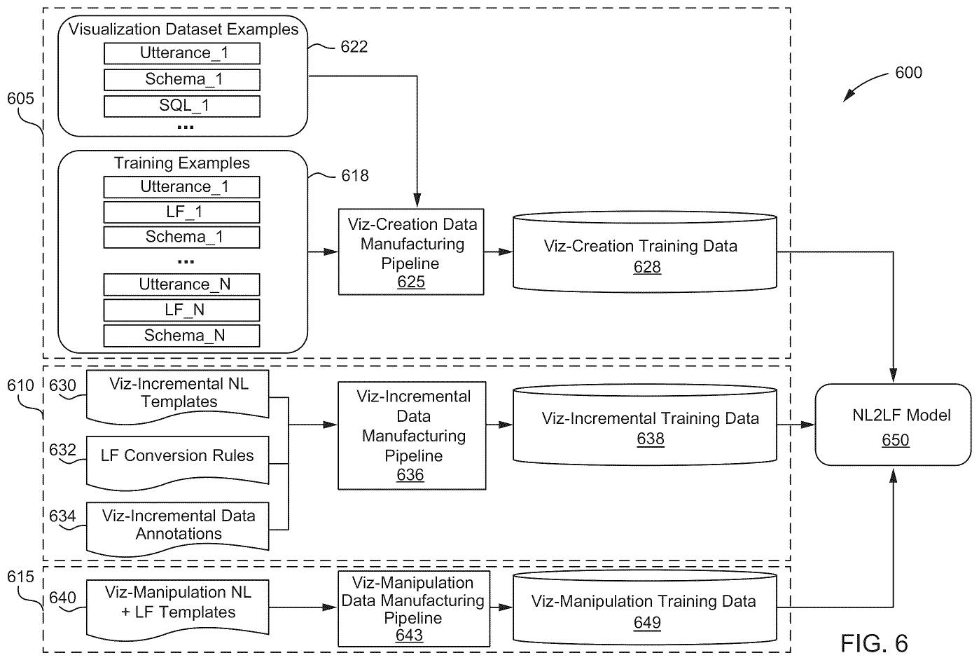

As discussed, large-scale, and high-quality visualization benchmark training data is virtually nonexistent for training a NL2LF model. To overcome this challenge and others, a data manufacturing framework (described in detail with respect to FIG. 6) is described herein to perform data augmentation and synthesis to (semi-) automatically generate visualization training examples. The framework accesses the original C20MRL training dataset, a visualization query dataset, an incremental visualization dataset, a manipulation visualization dataset, or any combination thereof and generates visualization training datasets. In order to generate the visualization training datasets, the framework modifies the examples in the original C20MRL training dataset, the visualization query dataset, or both to include visualization actions. Additionally or alternatively, the framework generates visualization training datasets using the incremental visualization dataset, the manipulation visualization dataset, or both, to include visualization actions. Once the visualization training datasets are generated, they are added to the original C20MRL training dataset to generate an augmented training dataset that is then used to train a machine learning model (e.g., a NL2LF model) to convert a natural language utterance into meaning representation language (MRL) logical form that includes one or more visualization actions.

While synthetic data and data augmentation performed within the data manufacturing framework share the goal of expanding the size and diversity of training data, they differ in their approaches. Synthetic data is newly generated (e.g., using templates and data generation algorithms), whereas data augmentation leverages existing training data to generate additional examples (e.g., by applying one or more transformations to the existing training data). Synthetic data offers advantages such as enhanced privacy, security protection, and addressing data scarcity challenges. Nonetheless, if not meticulously designed, the generation process for synthetic data may introduce biases or lack realism. In contrast, data augmentation is constrained by the quality and diversity of the original training data. Combining both synthetic data and data augmentation can optimize outcomes in deep learning applications including with respect to translating natural language to logical forms.

FIG. 6 illustrates a semi-automated data manufacturing framework 600 that generates training examples for visualization use-cases, which can then be used to train the C20MRL architecture (described with respect to FIGS. 4 and 5) to convert a natural language utterance into meaning representation language (MRL) logical form that includes one or more visualization actions. The data manufacturing framework 600 includes three components, each targeting one main query category from the categories shown and described with respect to Table 1 (viz-creation, viz-incremental, and viz-manipulation).

The first component is the visualization (viz)-creation data manufacturing component 605, which is a data-augmentation pipeline that automatically generates viz-creation examples by modifying examples in (1) a original training dataset (e.g., existing C20MRL training examples) 618, (2) a visualization query dataset 622 (e.g., a dataset from academia or other publicly available sources), or (3) both (1) and (2). Each example in the original training dataset may comprise a natural language utterance, a MRL logical form corresponding to the natural language utterance, and a schema. Each example in the visualization query dataset may comprise a natural language utterance, a system programming language corresponding to the natural language utterance, a visualization type presented in the natural language utterance, and a schema. The viz-creation data manufacturing component 605 uses a viz-creation data manufacturing pipeline 625 to generate viz-creation training data 628 for training a NL2LF model 650.

The second component is the viz-incremental data manufacturing component 610, which is a partially automated pipeline that generates viz-incremental examples from an incremental visualization dataset. The incremental visualization dataset comprises NL templates 630, logical-form (e.g., OMRQL) conversion rules 632, and annotations 634. The NL templates 630 are first instantiated by human data annotators along with additional metadata, then the LF is automatically derived, and the slots populated via a data generation algorithm using the conversion rules 632 and annotations 634. The viz-incremental data manufacturing component 610 uses its own viz-incremental data manufacturing pipeline 636 to generate viz-incremental training data 638 for training a NL2LF model 650.

Finally, the third component is the viz-manipulation data manufacturing component 615, which automatically generate viz-manipulation examples from a manipulation visualization dataset. The manipulation visualization dataset comprises manipulation templates (e.g., NL+LF templates) 640. The manipulation templates 640 are first instantiated by human data annotators along with additional metadata, then the slots are populated via a data generation algorithm. The viz-manipulation data manufacturing component 615 uses its own viz-manipulation data manufacturing pipeline 643 to generate viz-manipulation training data 649 for training a NL2LF model 650. Although FIG. 6 depicts the components 605, 610, and 615 occurring in a particular sequence or order, this is not intended to be limiting. In certain alternative embodiments, the components may be performed in a different order, some components may also be performed in parallel, or some components may not be performed at all.

### Viz-Creation Data Manufacturing Pipeline

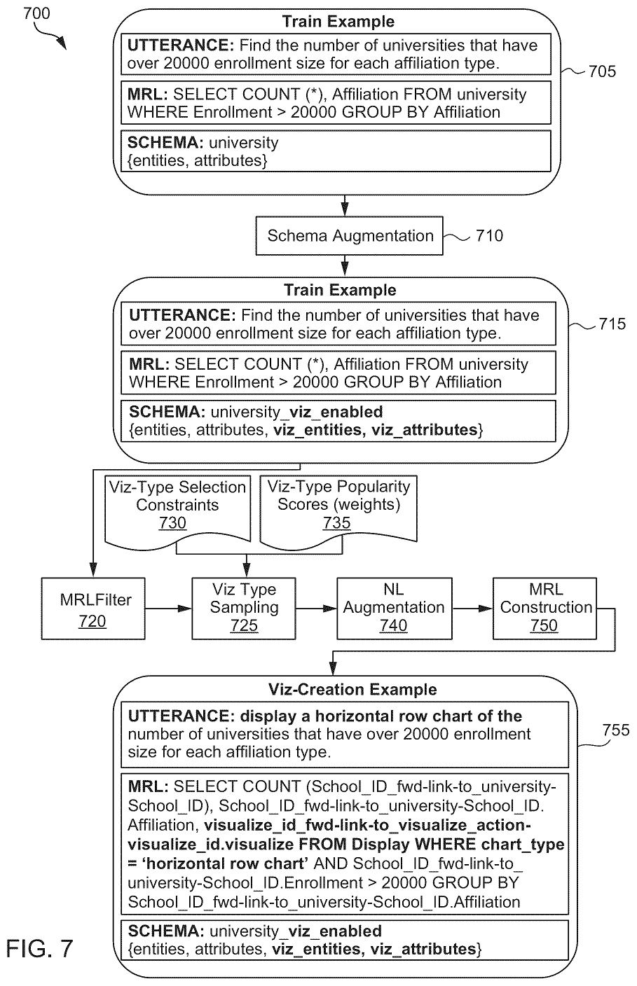

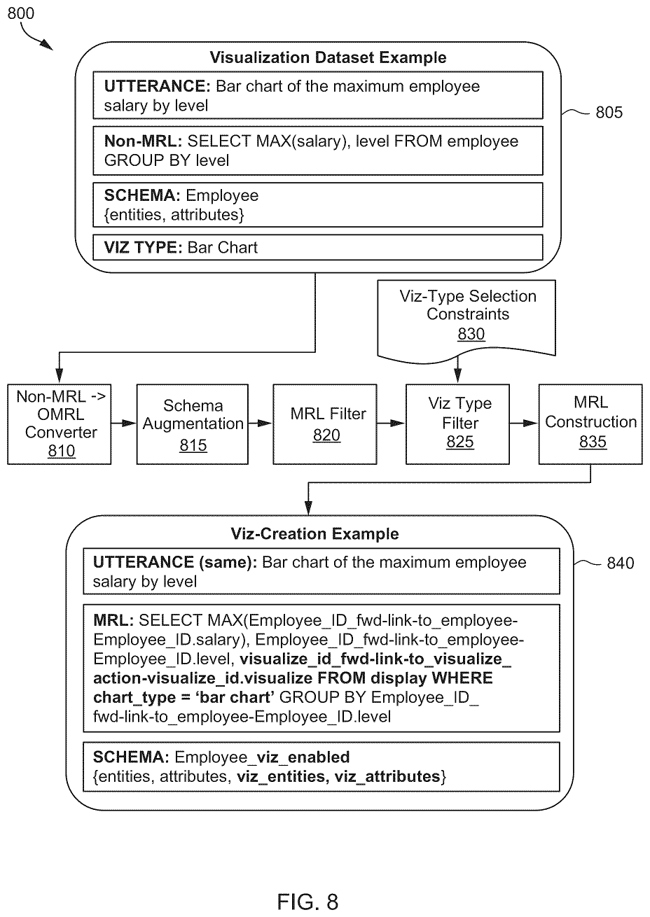

The viz-creation data manufacturing pipeline 625 is comprised of two separate pipelines: the MRL2VIS (e.g., C20MRL to visualization example) pipeline (described in detail with respect to FIG. 7) and the VIS2VIS (Public visualizations to visualization examples) pipeline (described in detail with respect to FIG. 8) that implement various tools and algorithms to augment and synthesize training examples. A “tool” as used herein refers to programs or applications implemented in software, hardware, or a combination thereof and designed to perform specific tasks or functions to aid in the completion of work or projects (e.g., augment training data, filter training data, modify schema, etc.). An “algorithm” as used herein refers to a sequence of instructions, typically used to solve a specific problem or to perform a computation. In some instances, only one of the two pipelines (the MRL2VIS pipeline or the VIS2VIS pipeline) is used to generate the viz-creation training data 628. In other instances, both pipelines (the MRL2VIS pipeline and the VIS2VIS pipeline) are used to generate the viz-creation training data 628 with each pipeline contributing a portion of the training examples to the viz-creation training data 628.

As shown in FIG. 7, the MRL2VIS pipeline 700 works by accessing examples 705 that are suitable for transformation into viz-creation examples, augmenting the original NL utterance (e.g., a query or command), and constructing the viz-creation MRL logical form (e.g., OMRQL). The examples 705 are accessed from the original training examples/dataset (e.g., existing C20MRL training examples, as described with respect to FIG. 6). Each example 705 comprises a NL utterance, a MRL (e.g., OMRQL) logical form corresponding to the NL utterance, and a schema (entity names, attribute names, list of links between entities, attribute types, other metadata, etc.). A NL utterance is the input provided by a user and in general refers to the intent of the user. For example, a text string in an incident's short description, a chat entry, an email subject line, a query to a search engine or chatbot, or the like, e.g., “Find the number of universities that have over 20,000 enrollment size for each affiliation type.” The logical form refers to the associated logical form of the utterance in a meaning representation language and/or machine-oriented language (e.g., a MRL logical form). As described herein, MRL provides a versatile intermediate representation of a natural language utterance that can be translated into any number of target machine-oriented languages (e.g., SQL). As such, MRL can be utilized by computing systems such as a chatbot to communicate interchangeably with both a human and various backend systems, including systems that communicate using SQL, APIs, REST, GraphQL, PGQL, OAC API, etc.

A schema defines how data is organized within a system such as a relational database; this includes logical constraints such as table names, fields, data types, and the relationships between various entities. For example, a relational database can be formed of one or more tables with each table of the one or more tables including one or more columns with each column of the one or more columns including one or more values. Each table and column of a relational database can be named with unique identifiers, each of which can include one or more words. In some instances, one or more columns of the relational database may serve as a primary key in which each of the values of the one or more columns that serve as the primary key are unique from each other. In some instances, one or more columns of the relational database may serve as a foreign key which serves to the link the table which includes the one or more columns with another table in the relational database. The schema information can include one or more data structures for storing the unique identifiers of the one or more tables, the unique identifiers of the one or more columns, and values of each relational database. In some instances, a data structure storing schema information for a relational database can store a directed graph representing the unique identifiers and values.

Metadata associated with the schema includes additional information concerning the schema, including synonyms for different words. For example, a car is a synonym for automobile. Using this additional information in the schema, name-based schema linking can be used to identify elements in the schema representation based on identifying synonyms as well as identifying an exact match. In other words, the schema-linking relations comprise metadata specifying synonyms for words (e.g., minimum, min, least, lowest, etc.). Schema linking involves identifying a value for identification in a system such as a relational database. For example, in the utterance “show invoices for customer Nike,” the schema linking specifies that Nike is a value for calling “vendor” in the database. Metadata for the schema linking is provided to the model, and the value linking helps the model make the right prediction. One example of such metadata for schema linking is a content-based schema linking (CBSL) match offset, which specifies what part of the utterance matches values. CBSL techniques are described in further detail in U.S. patent application Ser. No. 18/065,387, entitled “Transforming Natural Language To Structured Query Language Based On Scalable Search And Content-Based Schema Linking,” filed Dec. 13, 2022, the entire contents of which are incorporated herein by reference for all purposes. In some instances, name-based schema linking (NBSL) is applied. NBSL works to produce matching between tokens in the natural language utterance and elements in the schema representation. NBSL matches entities such as table names and column names to words in the input utterance, which can be based on an exact match or a partial match for both the primary name and its synonyms to elements in the schema representation.

After the examples 705 are accessed, a schema augmentation tool 710 extends the original schema (e.g., a database schema) in each example 705 or set of examples to generate a visualization labeled schema 715 by: (i) incorporating one or more visualization-related entities from a viz-enabled schema design into the original schema, and (ii) adding the connections (link attributes) between some of the visualization-related entities (e.g., the hub viz related entities such as (Display, Display_element) and the original schema entities (e.g., Display→university as illustrated in FIG. 7). Consequently, the visualization labeled schema 715 includes one or more visualization-related entities and schema-linking relations that link the one or more visualization-related entities to one or more system-related entities within the original schema. Visualization-related entities represent the different “visualization actions” within viz-creation, viz-incremental, and viz-manipulation utterances. Visualization actions are expressed as verbs in the NL utterance for any action that can be taken by a user with respect to a visualization (e.g., create, display, move, enlarge, include, exclude, replace, update, disable, visualize, etc.). The visualization-related entities are selected for representing the visualization actions from a viz-enabled schema design comprising hub or primary entities, actions (in the aforementioned visualization utterances) represented as entities, and attributes associated with the entities.

An exemplary viz-enabled schema design may look like the following:

Two hub entities can connect to different actions required for visualization:
1. “display” hub entity
   a. a primary entity for supporting viz-creation queries.
   b. the Display entity has one main action entity called “visualize_act”:
      i. “visualize_act” action entity:
         1. Its main attribute is “visualize” which is to represent
   c. the display entity has 2 common attributes:
      i. “chart_type” attribute:
         1. This attribute is to specify a type of visualization, e.g., chart, pie, bar, etc.
         2. It is often within a condition or a filter.
         3. It can also be with a pre-defined value list supported by the backend system such as the OAC platform.
         a. Note that this value list can be indexed and searched via a CBSL matching mechanism.
      ii. “chart_collection_type” attribute:
         1. This attribute is to specify whether it is a collection of a type (e.g., chart) of visualization or a single type of visualization. If unspecified, it is a single type of visualization by default.
         2. It can also be with a pre-defined value list (e.g., single/set/dashboard/canvas) supported the backend system such as the OAC platform.
   d. secondary actions: actions as entities have multiple attributes that effectively support visualization actions (viz-creation queries)
      i. Depending on the roles of actions, they can have multiple attributes. For example, move action (named as move_act) additionally has a “direction” attribute with a value list of “left”, “right”, “up”, “top”, and “bottom”.
2. “display_element” hub entity
   a. a primary entity for supporting other queries including viz-incremental and viz manipulation queries.
   b. The display_element entity has multiple attributes and actions.
      i. common attributes:
         1. are shared for the supporting actions.
         2. “element_name” attribute:
         a. for supporting action manipulating different objects of a given visualization, e.g., title, axis, legend, filter, grand total, . . . .
         3. other attributes include:
         a. “font”, “font_name”, “font_size”, . . . for actions manipulating on font object of a given visualization.
         i. These often have predefined value lists.
         b. “color” for action manipulating the color object of a given visualization.
      ii. actions: actions as entities have multiple attributes that effectively support visualization actions (viz-incremental and viz manipulation)
         1. Depending on the roles of actions, they can have multiple attributes. For example, move action (named as move_act) additionally has a “direction” attribute with a value list of “left”, “right”, “up”, “top”, and “bottom”.
3. Note that the display and display_element entities can also share some actions, e.g., include (represented as include_act entity), move (represented as move_act entity), and replace (represented as replace_act entity).
4. The two hub entities connect to existing so-called Fact entities (e.g., backend system data such as SQL Dialogs schemas or OAC datasets) via link attributes.
   a. Note that the Fact entities reserve their natural relationships via the link attributes.

Schema-linking relations add connections (i.e., link attributes) between the main viz-related entities and the natural language utterance of the original schema. The schema-linking relations provide information to help identify how the elements in the schema representation relate to the words in the natural language utterance. For example, to link the viz-related entity “display, display_element” to the original schema entity “university”. Schema linking serves to capture latent linking between tokens in utterances and schema (e.g., entities/attributes in OMRL or tables/columns in SQL). Table 3 below provides an example of an original and augmented schema as processed by the schema augmentation tool 710 using the above exemplary viz-enabled schema design.

TABLE 3

| Original Schema | Augmented Schema | |
|---|---|---|
| Schema id = university_basketball | Schema id = university_basketball_viz_enabled | |
| Click here to expand... | ▪ | Added viz-related entities (“display” entity, |
| [ | | “visualize_action” entity, etc.) |
| { | ▪ | Added link attributes to connect viz-related entities to the |
| “schema”: “university_basketball”, | | original ones (e.g., School_ID_fwd-link-to_university- |
| “version”: “0.1”, | | School_ID from “display” to “university”) |
| “entities”: [ | Click here to expand... | |
| ... | [ | |
| { | { | |
| “name”: “university”, | “schema”: “university_basketball_viz_enabled”, | |
| “attributes”: [ | “entities”: [ | |
| { | | ... |
| “name”: “School_ID”, | | { |
| “type”: “number” | | “name”: “university”, |
| }, | | “attributes”: [ |
| { | | { |
| “name”: “School”, | | “name”: “School_ID”, |
| “type”: “entity”, | | “type”: “number” |
| “entity_name”: | | }, |
| “university.School” | | { |
| }, | | “name”: “School”, |
| { | | “type”: “entity”, |
| “name”: “Affiliation”, | | “entity_name”: “university.School” |
| “type”: “number” | | }, |
| }, | | { |
| ... | | “name”: “Affiliation”, |
| ] | | “type”: “number” |
| }, | | }, |
| } | | ... |
| ] | | ] |
| | | }, |
| | | { |
| | | “name”: “display”, |
| | | “attributes”: [ |
| | | { |
| | | “name”: “display_id”, |
| | | “type”: “number” |
| | | }, |
| | | { |
| | | “name”: “chart_type”, |
| | | “type”: “entity”, |
| | | “entity_name”: “display.chart_type” |
| | | }, |
| | | { |
| | | “name”: “chart_collection_type”, |
| | | “type”: “entity”, |
| | | “entity_name”: “display.chart_collection_type” |
| | | }, |
| | | { |
| | | “name”: “visualize_id_fwd-link- |

to_visualize_action-visualize_id”,

```
      “type”: “composite_entity”,
      “entity_name”: “visualize_action”,
      “multiple_values”: false
    },
    ...
    {
      “name”: “School_ID_fwd-link-to_university-
```

School_ID”,

```
      “type”: “composite_entity”,
      “entity_name”: “university”,
      “multiple_values”: false
    }
  ]
},
...
{
  “name”: “visualize_action”,
  “attributes”: [
    {
      “name”: “visualize_id”,
      “type”: “number”
    },
    {
      “name”: “visualize”,
      “type”: “entity”,
      “entity_name”: “visualize_action.visualize”
    }
  ]
}
```

```
    ]
  }
]
```

A logical form (e.g., OMRQL) filter tool 720 may be used to filter the examples 705 (with the original schema or the visualization labeled schema 715), based on analysis of the MRL logical form using filtering rule(s), to identify examples that meet a set criteria. The examples that meet the set criteria are output by the logical form filter tool 720 and used to ultimately generate the viz-creation training data. Exemplary filtering rules, without limitation, along with the rationale for the rules are provided in Table 4.

TABLE 4

| Filtering Rule (on OMRQL) | Rationale |
|---|---|
| Keep only queries with | Used to select those training examples with “analytical” queries, i.e. |
| GROUP BY | queries with clear “measure vs dimension” or “measure vs measure” |
| | relations, which can be cast into charts/plots. |
| | Example: show average employee salary by age |
| | SELECT AVG(salary), age FROM employee GROUP BY age |
| | ▪ this example includes a measure (salary) vs measure (age) |
| | relation |
| | ▪ e.g., this can be visualized as a line chart |
| | Example: Find the number of universities that have more than 2000 |
| | enrollment size for each affiliation type |
| | SELECT COUNT(*), Affiliation FROM university WHERE |
| | Enrollment > 20000 GROUP BY Affiliation |
| | ▪ this example includes a measure (count of universities) vs |
| | dimension (affiliation type) |
| | ▪ e.g., this can be visualized as bar chart |
| Remove queries with | The GROUP BY + HAVING clause (in OMRL as well as in SQL) is |
| HAVING | used to express a filter (with aggregation), rather than an explicit |
| | “measure vs dimension”/“measure vs measure” relation. It would |
| | require manual annotations to transform the query, e.g. |
| | e.g., “show companies with average salary above 10K” → relation: |
| | “average salary by company.” |
| | Thus, used to filter out these kind of queries and avoid the manual |
| | annotations. |
| Remove queries with ID- | Queries with “ID-columns” (ids, codes, phone numbers, ...) used as |
| columns as measure | measure (i.e., with aggregation) are generally not suitable for |
| | visualization. |
| | For example: |
| | e.g., “show average employee id by company” (not suitable for viz) |
| | e.g., “show minimum version id by application” (ok) |
| | Thus, used to filter out these kinds of queries and avoid manual |
| | example review. |
| Remove queries with one or | Hard to automatically transform these queries into Viz-Creation |
| more sub-queries and set- | queries. |
| operators (EXCEPT, | Require manual (one-by-one) example review. |
| INTERSECT, UNION, IN) | Thus, used to filter out these kinds of queries and avoid manual |
| | example review. |

Once the examples 705 are accessed and optionally filtered, the viz-type sampling tool 725 selects a visualization type (e.g., chart, graph, animation, etc.) for each example or set of examples (can be a subset of all examples 705 accessed or all examples 705 accessed) to generate viz-creation training example(s). The selection decision may be made based on the visualization-type selection constraints 730 and popularity scores 735 associated with each visualization type. The visualization-type selection constraints 730 are a set of rules that determine what visualization type makes sense for a viz-creation training based on properties of the MRL (e.g., conditions or operations) in the example(s). The rationale is to craft viz-creation training examples that resemble real customer visualization use cases. Exemplary visualization-type selection constraints 730 for various OMRQL constraints are provided in Table 5.

TABLE 5

| | Condition (on OMRQL) | Constraint | | | | |
|---|---|---|---|---|---|---|
| 1 | SELECT and GROUP-BY attributes are both | Sample from: {line chart, scatter plot, ..} | | | | |
| | measurable | | ▪ | chart type should be generally suitable to | | |
| | (e.g., with type=number in the Schema) | | | “measure vs measure” visualization | | |
| | | | ▪ | Example: “show profit by sales” → | | |
| | | | | | ▪ | “create a line chart of profit by sales” |
| | | | | | | [symbol] |
| | | | | | ▪ | “visualize a bar chart of profit by sales” |
| | | | | | | [symbol] |
| 2 | GROUP BY attribute is categorical (e.g., | Sample from: {bar chart, pie chart, ..} | | | | |
| | “product_category”, “customer_type”) | | ▪ | Example: “show profit by customer category” | | |
| | | | | | ▪ | “visualize a bar chart of profit by |
| | | | | | | customer category” [symbol] |
| | | | | | ▪ | “visualize a scatter plot of profit by |
| | | | | | | customer category” [symbol] |
| 3 | Multiple SELECT attributes that are | Sample from: {horizontal stacked bar chart, vertical | | | | |
| | measurable | stacked bar chart, set of bar charts,...} | | | | |
| | | | ▪ | Example: “show profit and sales for each | | |
| | | | | customer segment” | | |
| | | | | | ▪ | “visualise a horizontal stacked bar chart |
| | | | | | | of profit and sales for each customer |
| | | | | | | segment” [symbol] |
| | | | | | ▪ | “visualise a set of bar charts of profit |
| | | | | | | and sales for each customer segment” |
| | | | | | | [symbol] |
| | | | | | ▪ | “create a bar chart of profit and sales |
| | | | | | | for each customer segment” [symbol] |

| 4 | GROUP BY attribute of type date-time | | Sample from: {bar chart, pie chart, ..} OR | | |
|---|---|---|---|---|---|
| | | | Sample from: {time series chart} | | |
| | | | | ▪ | Added time-series chart family for date-time |
| | | | | | attributes |
| 5 | GROUP BY attribute is geographical | | Sample from: {bar chart, pie chart, ..} OR | | |
| | ▪ | (regex)matching: {geo, location, lat, | Sample from: {map} | | |
| | | long, city, region, ..} | | ▪ | Added “map” charts for geographical attributes |

The popularity scores 735 are a list of weights associated with each visualization type, to be used for weighted sampling. The list of weight is derived from user visualization request counts/frequencies shared by a backend system such as OAC (e.g., the number of times each type of visualization is requested by a user from the backend system).

After accessing examples 705 and selecting a visualization type for each example or set of examples, the next step in the MRL2VIS pipeline 700 is to augment or modify the original NL utterance in the examples 705 to include a visualization clause, which generates a visualization creation utterance. This can be done in three primary operations using the NL augmentation tool 740.
Operation 1: remove the prefix, or the suffix, or both from the original NL utterance with a regex-based pattern (see Table 6 below). The regex-based pattern may be provided by a user such as a developer or customer.

TABLE 6

| Original Utterance | Pattern (simplified) | Output |
|---|---|---|
| Find the number of universities that | {show, show all, find, | the number of universities that have |
| have more than 2000 enrollment size | return,..}...{by, for each, | more than 2000 enrollment size for |
| for each affiliation type | group by}... | each affiliation type |
| Show average employee salary by age | {show, show all, find, | average employee salary by age |
| | return,..}...{by, for each, | |
| | group by}... | |
| For each customer segment, show the | {For each, in each, | For each customer segment, the total |
| total profit | ..}...{show, show all, find, | profit |
| | return,..} | |

Operation 2: integrate an empty visualization clause into the NL utterance by randomly instantiating a visualization clause template (see Table 7 below). The visualization clause template may be provided by a user such as a developer or customer.

TABLE 7

| | | Visualization | |
|---|---|---|---|
| Pattern (simplified) | Input | clause template | Output |
| {show, show all, | the number of | {create, generate, render, | create a <CHART_TYPE> with |
| find, return,..}...{by, | universities that have | visualize, ..} a | the number of universities that have |
| for each, group by}... | more than 2000 | <CHART_TYPE> {with, | more than 2000 enrollment size for |
| | enrollment size for | of, showing..} | each affiliation type |
| | each affiliation type | | |
| {show, show all, | average employee | {create, generate, render, | visualize a <CHART_TYPE> of |
| find, return,..}...{by, | salary by age | visualize, ..} a | average employee salary by age |
| for each, group by}... | | <CHART_TYPE> {with, | |
| | | of, showing..} | |
| {For each, in each, | For each customer | {create, generate, render, | render a <CHART_TYPE> |
| ..}...{show, show all, | segment, the total | visualize, ..} a | showing, for each customer |
| find, return,..} | profit | <CHART_TYPE> | segment, the total profit |
| | | {representing, showing..} | |

Operation 3: fill the empty slots (i.e., blank spaces to be filled using customized data) of the visualization clause template with the visualization type selected by the viz-type sampling tool 725. Continuing with the example above:
   Input (visualization clause template): Create a <CHART_TYPE> with the number of universities that have more than 2000 enrollment size for each affiliation type.
   Final Output (visualization creation utterance): Create a bar chart with the number of universities that have more than 2000 enrollment size for each affiliation type.
      This process performed by the NL augmentation tool 740 results in each NL utterance in the examples 705 having a visualization clause that includes a visualization action for a selected visualization type.

Next, a MRL construction tool 750 modifies, based on the visualization labeled schema and the visualization type selected for the example, the MRL logical form associated with each of the examples 705 to generate a visualization creation MRL logical form that corresponds to the visualization creation utterance augmented by the NL augmentation tool 740. This process includes four primary operations:
Operation 1: extract the original root entity (e.g., the entity in the FROM clause), for example:
   SELECT COUNT (*), Affiliation FROM university WHERE Enrollment>20000 GROUP BY Affiliation→university
Operation 2: replace the root entity with a hub or primary entity (e.g., the display entity) in the visualization labeled schema 715 obtained from the schema augmentation tool 710, for example:
   SELECT COUNT (*), Affiliation FROM university WHERE Enrollment>20000 GROUP BY Affiliation→SELECT COUNT (*), Affiliation FROM display WHERE Enrollment>20000 GROUP BY Affiliation
Operation 3: replace each attribute in the MRL with an attribute from the visualization labeled schema 715 associated with the hub or primary entity, for example:
   Replace each <attribute> in the OMRQL with <link_from_display>.<attribute>
   <link_from_display>=School_ID_fwd-link-to_university-School_ID
   OMRQL=SELECT COUNT (School_ID_fwd-link-to_university-School_ID), School_ID_fwd-link-to_university-School_ID. Affiliation WHERE School_ID_fwd-link-to_university-School_ID. Enrollment>20000 GROUP BY School_ID_fwd-link-to_university-School_ID. Affiliation
Operation 4: add the visualization clause using the visualization type selected by the viz-type sampling tool 725, for example:
   selected viz type=“bar chart”
   OMRQL (final)=SELECT COUNT (School_ID_fwd-link-to_university-School_ID), School_ID_fwd-link-to_university-School_ID. Affiliation, visualize_id_fwd-link-to_visualize_action-visualize_id.visualize FROM display WHERE chart_type=‘horizontal row chart’ AND School_ID_fwd-link-to_university-School_ID.Enrollment>20000 GROUP BY School_ID_fwd-link-to_university-School_ID.Affiliation
      This process performed by the MRL construction tool 750 results in each of the examples 705 having a visualization creation MRL logical form that comprises one or more visualization-related entities and a visualization clause that includes the visualization action for the visualization type.

Lastly, the visualization labeled schema, the visualization creation utterance, and the visualization creation MRL logical form are assembled to generate a new visualization example 755. The MRL2VIS pipeline 700 may be repeated for a random or predefined number of examples or sets of examples in the original training dataset to generate all or a portion of the viz-creation training data 628 described with respect to FIG. 6.

As shown in FIG. 8, the VIS2VIS pipeline 800 works by accessing examples 805 that are suitable for transformation into viz-creation examples, converting an original logical form into MRL logical form, and constructing, based on the MRL logical form, the viz-creation MRL logical form (e.g., OMRQL). The examples 805 are accessed from a visualization query dataset (e.g., a dataset from academia or other publicly available sources, as described with respect to FIG. 6 such as the NVBench Public dataset). Each example 805 comprises a NL utterance, a system programming language corresponding to the NL utterance, a visualization type presented in the NL utterance, and a schema (entity names, attribute names, list of links between entities, attribute types, other metadata, etc.). There are several differences between the examples 805 in the visualization query dataset and the examples 705 in the original training examples/dataset. These difference include: (1) the utterance, which already includes a visualization clause (e.g. “Bar chart of the maximum employee salary by level”) providing at least one visualization action for the visualization type given, (2) the logical form is not in MRL form, but is in a non-MRL form such as a system programming language (e.g., SQL, APIs, etc.) that can be converted to MRL, and (3) the visualization type is already annotated as part of the visualization query dataset.

After the examples 805 are accessed, a non-MRL→MRL converter tool 810 converts the non-MRL/system programming language into the MRL logical form of the corresponding NL utterance (e.g., OMRL). Techniques for converting between non-MRL↔MRL are described in U.S. patent application Ser. No. 18/209,844, entitled “Techniques For Converting A Natural Language Utterance To An Intermediate Database Query Representation,” filed Jun. 14, 2023, the entire contents of which are incorporated herein by reference for all purposes.

A schema augmentation tool 815 extends the original schema in each example 805 or set of examples to generate a visualization labeled schema by: (i) incorporating one or more visualization-related entities from a viz-enabled schema design into the original schema, and (ii) adding the connections (link attributes) between some of the visualization-related entities and the original schema entities, as described in detail with respect to FIG. 7). Consequently, the visualization labeled schema includes one or more visualization-related entities and schema-linking relations that link the one or more visualization-related entities to one or more system-related entities within the original schema.

A logical form (e.g., OMRQL) filter tool 820 may be used to filter the examples 805 (with the original schema or the visualization labeled schema 815), based on analysis of the MRL logical form (generated by the converter tool 810) using filtering rule(s), to identify examples that meet a set criteria. The examples that meet the set criteria are output by the logical form filter tool 820 and used to ultimately generate the viz-creation training data. Exemplary filtering rules, without limitation, along with the rationale for the rules are provided in Table 4.

Once the examples 805 are accessed, the MRL is generated, and the examples are optionally filtered, a viz-type filtering tool 825 determines whether the visualization type (e.g., chart, graph, animation, etc.) for each example or set of examples (can be a subset of all examples 805 accessed or all examples 805 accessed) is valid for MRL based on visualization-type selection constraints 830 (same constraints as the visualization-type selection constraints 730 described with respect to FIG. 7). The rationale is to ensure the training examples that were originally constructed for use with a non-MRL logical form will work for training examples that utilize an MRL logical form. Exemplary visualization-type selection constraints 830 for various OMRQL constraints are provided in Table 5.

Next, a MRL construction tool 835 modifies, based on the visualization labeled schema and the visualization type validated for the example, the MRL logical form associated with each of the examples 805 to generate a visualization creation MRL logical form that corresponds to the original utterances in the examples 805. As described in detail with respect to FIG. 7, this process includes four primary operations:
Operation 1: extract the original root entity (e.g., the entity in the FROM clause).
Operation 2: replace the root entity with a hub or primary entity (e.g., the display entity) in the visualization labeled schema obtained from the schema augmentation tool 815.
Operation 3: replace each attribute in the MRL with an attribute from the visualization labeled schema associated with the hub or primary entity.
Operation 4: add the visualization clause using the visualization type validated by the viz-type filtering tool 825.
   This process performed by the MRL construction tool 835 results in each of the examples 805 having a visualization creation MRL logical form that comprises one or more visualization-related entities and a visualization clause that includes the visualization action for the visualization type.

Lastly, the visualization labeled schema, the original utterance, and the visualization creation MRL logical form are assembled to generate a new visualization example 840. The VIS2VIS pipeline 800 may be repeated for a random or predefined number of examples or sets of examples in the visualization query dataset to generate all or a portion of the viz-creation training data 628 described with respect to FIG. 6.

### Viz-Incremental Data Manufacturing Pipeline

With reference back to FIG. 6, the viz-incremental data manufacturing pipeline 636 may be used alternatively, or in parallel with the viz-creation data manufacturing pipeline 625 and/or the viz-manipulation data manufacturing pipeline 643 to generate viz-incremental training data 638 for training a NL2LF model 650. By using simple data annotations and hiding the complexity of the viz-enabled schema design from annotators, the speed of collecting viz-incremental training data 638 greatly increases and the possibility of human mistake from misinterpretation of the schema specifications or hardening of the target MRL logical form reduces. Examples for how a visualization may be refined (incremental use-case types) include:
Adding/removing filter:
   Add a filter on Sales greater than 2.5 million
Adding/removing/replacing columns in the visualization:
   Replace sales with profit in the visualization
Sort actions:
   Sort the sales from low to high

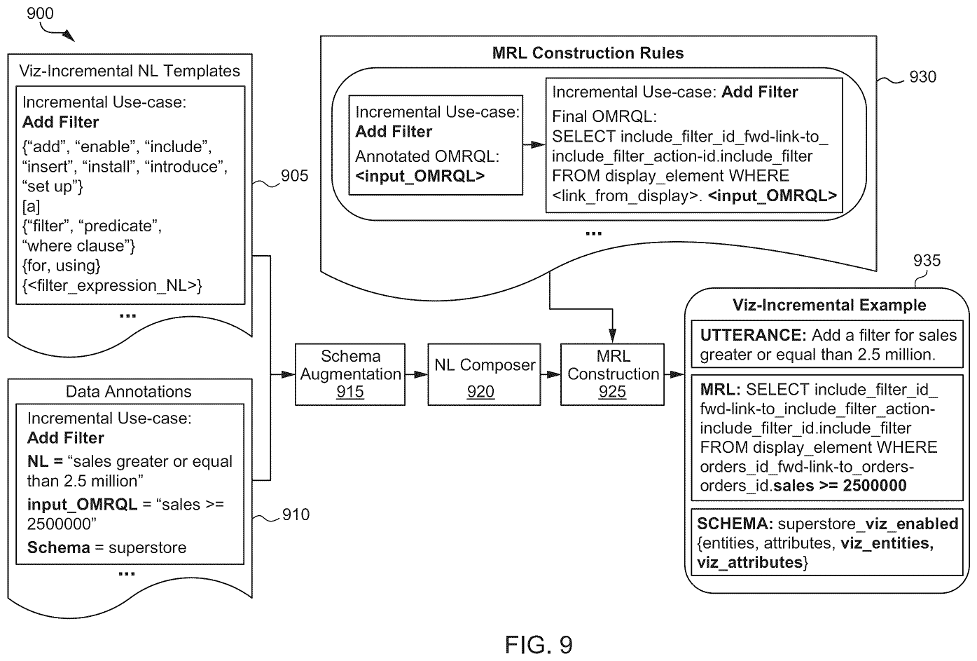

As shown in FIG. 9, the viz-incremental data manufacturing pipeline 900 works by accessing incremental NL templates 905 and data annotations 910, composing, based on the incremental NL templates 905 and annotations 910, visualization example utterances, and constructing, based on the annotations 910, a viz-incremental MRL logical form (e.g., OMRQL). The incremental NL templates 905 and data annotations 910 are accessed from an incremental visualization dataset (e.g., a dataset generated by a user such as a developer and saved to a data storage). The incremental NL templates 905 include a library of different text including various utterance forms (e.g., phrasings) to be used for each incremental use-case type. The data annotations 910 include the incremental use-case type to be used in the visualization example utterance, a base NL utterance associated with the incremental use-case type, an input MRL logical form associated with the incremental use-case type (e.g., a snippet of OMRQL), and an original schema.

A schema augmentation tool 915 extends the original schema in each data annotation 910 or set of data annotations 910 to generate a visualization labeled schema by: (i) incorporating one or more visualization-related entities from a viz-enabled schema design into the original schema, and (ii) adding the connections (link attributes) between some of the visualization-related entities and the original schema entities, as described in detail with respect to FIG. 7). Consequently, the visualization labeled schema includes one or more visualization-related entities and schema-linking relations that link the one or more visualization-related entities to one or more system-related entities within the original schema.

A NL composer tool 920 composes a visualization example NL utterance by instantiating an incremental NL template 905 using the base NL utterance from the data annotations 910. More specifically, the instantiating comprises the NL composer tool 920 selecting various terms (including one or more visualization actions) from the incremental NL template 905 based on the incremental use-case type and filling one or more slots of the incremental NL template 905 using text from the base NL utterance. For example:
Given a base NL utterance (from data annotation 910)=“sales greater or equal than 2.5 million”
Given incremental NL template 905=
   {“add”, “enable”, “include”, “insert”, “install”, “introduce”, “set up”}
   [a]
   {“filter”, “predicate”, “where clause”}
   {for, using}
   Slot→{<filter_expression>}
The visualization example NL utterance=insert a filter for sales greater or equal than 2.5 million
   In other words, the NL composer tool 920 extracts from the data annotation 910 the specified incremental use-case with a visualization action (e.g., Add Filter) and the base NL utterance (e.g., “sales greater or equal than 2.5 million”). Then, using the different utterance forms/phrasing provided by the incremental NL templates 905, composing the final output utterance (e.g., “Add a filter for sales greater or equal than 2.5 million”) that is used in the final viz-incremental training example.

A MRL constructor tool 925 generates the viz-incremental logical form (e.g., OMRQL) based on the input MRL logical form (e.g., input_OMRQL=“sales>=2500000”) from the data annotation 910 and a set of MRL logical form construction rules 930 defined for each viz-incremental use-case. More specifically, the MRL constructor tool 925 identifies the incremental use-case type from the annotations, uses a look-up table to identify one or more MRL logical form construction rules 930 defined for the incremental use-case type, and uses the one or more MRL logical form construction rules 930 to construct the viz-incremental logical form based on the input MRL logical form. See Table 8 for several examples.

TABLE 8

| | Use Case | OMRQL construction rule(s) | Examples | |
|---|---|---|---|---|
| 1 | Add | SELECT include_filter_id_fwd-link- | ▪ | NL = “add a filter on Sales |
| | Filter | to_include_filter_action-id.include_filter FROM | | greater than 2.5 million“ |
| | | display_element WHERE | ▪ | input_expression: “sales >= |
| | | <link_from_display>.<input_expression> | | 2500000“ |
| | | | ▪ | <link_from_display> |
| | | | | = orders_id_fwd-link-to_orders- |
| | | | | orders_id |
| | | | ▪ | final OMRQL = SELECT |
| | | | | include_filter_id_fwd-link- |
| | | | | to_include_filter_action- |
| | | | | include_filter_id.include_filter |
| | | | | FROM display_element |
| | | | | WHERE orders_id_fwd-link- |
| | | | | to_orders-orders_id.sales >= |
| | | | | 2500000 |
| 2 | Remove | SELECT exclude_filter_id_fwd-link- | ▪ | NL: “remove the filter on |
| | Filter | to_exclude_filter_action-id.exclude_filter, | | region“ |
| | | <link_from_display>.<input_expression> FROM | ▪ | input_expression: “region“ |
| | | display_element | ▪ | <link_from_display> |
| | | | | = orders_id_fwd-link-to_orders- |
| | | | | orders_id |
| | | | ▪ | final OMRQL = |
| | | | ▪ | SELECT exclude_filter_id_fwd- |
| | | | | link-to_exclude_filter_action- |
| | | | | id.exclude_filter, orders_id_fwd- |
| | | | | link-to_orders-orders_id.region |
| | | | | FROM display_element |
| 3 | Add | SELECT include_id_fwd-link-to_include_action- | ▪ | NL = Include product category |
| | Attribute | id.include, | | in the viz. |
| | | <link_from_display>.<input_expression> FROM | ▪ | input_expression: “product |
| | | display_element | | category“ |
| | | | ▪ | <link_from_display> |
| | | | | = orders_id_fwd-link-to_orders- |
| | | | | orders id |
| | | | ▪ | final OMRQL = SELECT |
| | | | | include_idfwd-link- |
| | | | | to_include_action-id.include, |
| | | | | orders_id_fwd-link-toorders- |
| | | | | orders_id.product_category |
| | | | | FROM display_element |

Lastly, the visualization labeled schema, the visualization example utterance, and the visualization incremental MRL logical form are assembled to generate a new visualization example 935. The viz-incremental data manufacturing pipeline 900 may be repeated for a random or predefined number of examples to generate the all or a portion of the viz-incremental training data 638 described with respect to FIG. 6.

### Viz-Incremental Data Manufacturing Pipeline

With reference back to FIG. 6, the viz-manipulation data manufacturing pipeline 643 may be used alternatively, or in parallel with the viz-creation data manufacturing pipeline 625 and/or the viz-incremental data manufacturing pipeline 636 to generate viz-manipulation training data 649 for training a NL2LF model 650. The viz-manipulation data manufacturing pipeline 643 handles utterance (e.g., queries) that modify the appearance of a visualization. These utterances do not depend on the original schema information (e.g., from the viz-creation or viz-incremental training examples), since they do not invoke any of the original entities/attributes (e.g., no reference to “orders” or “university” or “employees” from the previous schemas). Some examples of viz-manipulation use cases are:
<Change the chart type>:
   Change this to use a pie chart
   Switch the chart type
<Change the title font>
   Color the title font blue
   Make the title font bigger
<Change number format>
   Change the member format to USD

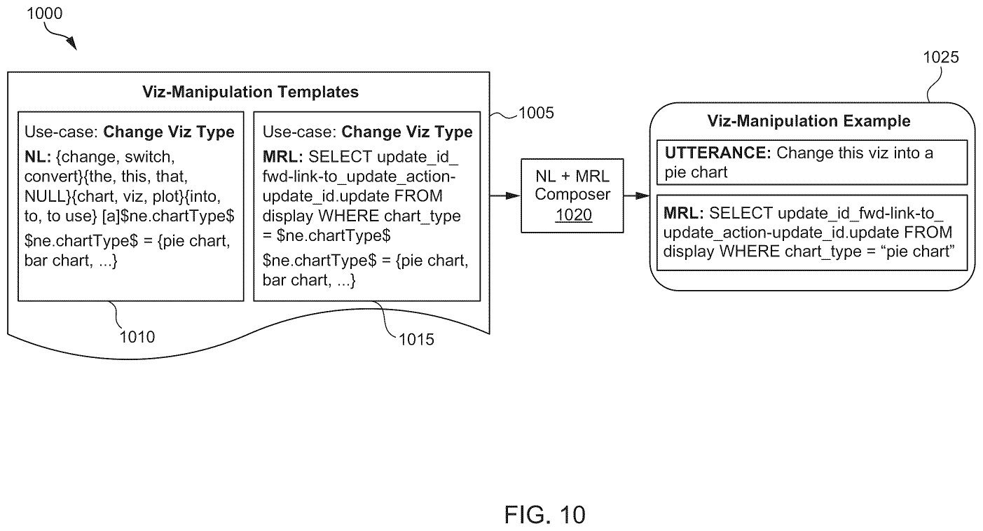

As shown in FIG. 10, the viz-manipulation data manufacturing pipeline 1000 works by accessing manipulation templates 1005 and composing, using the manipulation templates 1005, new visualization examples comprising a visualization example utterance and a corresponding visualization manipulation MRL logical form. The manipulation templates 1005 are accessed from a manipulation visualization dataset (e.g., a dataset generated by a user such as a developer and saved to a data storage). The manipulation templates 1005 include a manipulation NL component 1010 and a corresponding MRL (e.g., OMRQL) component 1015. The manipulation NL component 1010 includes a use-case type (e.g., “Change Viz Type”), a NL utterance definition (e.g., subjects like “chart”, “viz”; verbs like “change”, “switch”, . . . ), and a visualization-type value. The corresponding MRL component 1015 includes a use-case type, a visualization-type value, and a MRL logical form definition. The manipulation templates 1005 are input into a NL+MRL composer 1020 which selects values (values are provided as part of the template definition) to instantiate the manipulation templates 1005 and generate a visualization example utterance and a corresponding visualization manipulation MRL logical form. Some of the values are only used for the utterance (e.g., subjects like “chart”, “viz”; verbs like “change”, “switch”, . . . ). Other values (e.g., chart-type values) are used for both the utterance and MRL. These values may be referred to as “named entities”, but they should not be confused with the schema entities.

Lastly, the visualization example utterance and the visualization manipulation MRL logical form are assembled to generate a new visualization example 1025. The visualization examples 1025 are schema-agnostic and as such they don't refer to any schema attribute/entity. The viz-manipulation data manufacturing pipeline 1000 may be repeated for a random or predefined number of examples to generate the all or a portion of the viz-manipulation training data 649 described with respect to FIG. 6.

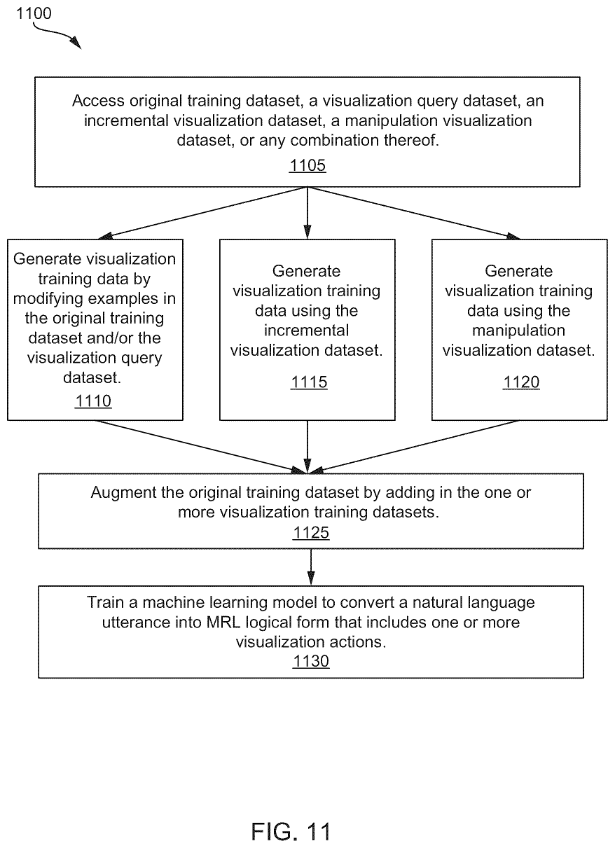

FIG. 11 is a flowchart illustrating a process 1100 for using artificial intelligence-based techniques to manufacture visualization training data to be used for training a machine learning model to transform NL into a visualization representation in accordance with various embodiments. The processing depicted in FIG. 11 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 11 and described below is intended to be illustrative and non-limiting. Although FIG. 11 depicts the various processing steps occurring in a particular sequence or order, this is not intended to be limiting. In certain alternative embodiments, the steps may be performed in some different order, or some steps may also be performed in parallel. In certain embodiments, such as in the embodiments depicted in FIGS. 6-10, the processing depicted in FIG. 11 may be performed by a semi-automated data manufacturing framework (e.g., described with respect to FIG. 6) and its three components (e.g., the viz-creation data manufacturing component described in FIGS. 6 and 8, the viz-incremental data manufacturing component described in FIGS. 6 and 9, and the viz-manipulation data manufacturing component described in FIGS. 6 and 10) to manufacture an augmented training dataset of visualization examples to train a machine learning model (e.g., the C20MRL platform) to convert a natural language utterance into MRL logical form that includes one or more visualization actions.

Starting at block 1105, an original training dataset, a visualization query dataset, an incremental visualization dataset, a manipulation visualization dataset, or any combination thereof are accessed. Each example from the original training dataset comprises a natural language utterance, a MRL logical form corresponding to the natural language utterance, and a schema. In some instances, the original training dataset includes examples from general domain datasets that do not comprise visualization examples. For example, hundreds, thousands, or tens of thousands of training examples from general domain datasets are accessed. Importantly, the original training dataset does not include visualization entities/attributes. In other instances, the original training dataset could be any public or private dataset compatible with NL2LF systems that does not contain visualization entities/attributes. The visualization query dataset is a dataset that does comprise visualization examples. For example, each example in the visualization query dataset comprises a natural language utterance, a system programming language corresponding to the natural language utterance, a visualization type presented in the natural language utterance, and a schema. In some instances, the visualization query dataset is accessed from a visualization query dataset such as a dataset from academia or other publicly available sources (e.g. the NVbench Public dataset) so long as their logical from (e.g., SQL) can be converted to MRL. The incremental visualization dataset comprises one or more data annotations and incremental NL templates. Finally, the manipulation visualization dataset comprises one or more manipulation templates. Accessing the original training dataset, the visualization query dataset, the incremental visualization dataset, the manipulation visualization dataset, or any combination thereof may include retrieving the dataset from a remote or local data store.

At box 1110, visualization training datasets are generated by modifying examples in the original training dataset and/or the visualization query dataset. To modify examples in the original training dataset, the MRL2VIS pipeline described in FIG. 6 and FIG. 7 implements various tools and algorithms to augment a portion, or all, of the training examples that comprise the viz-creation training data. The MRL2VIS pipeline comprises steps (a) through (g) described below that may be performed in any order or in parallel to generate viz-creation training data for training a NL2LF model.
a) An example from the original training dataset is accessed that is suitable for transformation into a viz-creation example. This example may comprise (i) a schema associated with the example, (ii) a NL utterance, and (iii) a MRL logical form associated with the example.
b) To the schema, one or more visualization-related entities and schema-linking relations that link the one or more visualization-related entities to one or more entities within the schema are added to generate a visualization labeled schema. The one or more visualization-related entities represent different “visualization actions” within viz-creation, viz-incremental, and viz-manipulation utterances. With respect to the schema, the visualization actions are selected from a viz-enabled schema design that comprises hub or primary entities, actions represented as entities, and attributes associated with the entities.
c) A visualization type (e.g., chart, graph, animation, etc.) for the example is selected based on the visualization-type selection constraints of the MRL logical form and popularity scores associated with each visualization type. The visualization-type selection constraints (described in Table 5) are a set of rules that ensures an appropriate visualization type is selected for the example based on the properties (e.g., conditions or operations) of the MRL. The popularity scores are a list of weights associated with each chart type, to be used for weighted sampling. In some instances, the popularity scores are derived from visualization request counts/frequencies obtained from a public source (e.g., the Oracle Analytics Cloud).
d) To the NL utterance associated with the example, a visualization clause is added using a visualization clause template and the visualization type selected for the example from step (c) to generate a visualization creation utterance. This can be done in three primary operations that include (1) removing the prefix, or suffix, or both from the original NL utterance, (2) integrating an empty visualization clause into the NL utterance, and (3) filling the empty visualization clause with the selected visualization type. The visualization clause template includes a visualization action (e.g., create, generate, render, visualize, etc.) for the visualization type.
e) The MRL logical form associated with the example is modified based on the visualization labeled schema, from (b), and the visualization type selected for the example, from (c), to generate a visualization creation MRL logical form that corresponds to the visualization creation utterance created in (d). This process uses four primary operations that briefly include (1) extracting the original root entity, (2) replacing the root entity with a hub or primary entity in the visualization labeled schema, (3) replacing each attribute in the MRL with an attribute from the visualization labeled schema associated with the hub or primary entity, and (4) adding the visualization clause with the selected visualization type. From this process, the visualization creation MRL logical form comprises one or more visualization-related entities and a visualization clause that includes the visualization action for the visualization type.
f) A new visualization example is generated once the visualization labeled schema, the visualization creation utterance, and the visualization creation MRL logical form are assembled together.
g) Steps (a) and (c)-(f) may be repeated for a random or predefined number of examples in the original training dataset to generate a portion, or all, of the visualization training dataset of the one or more visualization training datasets, the visualization training dataset comprising the new visualization examples.

In some embodiments, modifying the examples in the original training dataset may further comprise, that prior to performing step (c), the examples are optionally filtered to determine if they are suitable for augmentation or not, based on analysis of their MRL logical form. Analysis of the MRL logical form uses a set of filtering rules (described in Table 4), and steps (c)-(f) may only be performed when the example is determined to be suitable for augmentation. A suitable example, without limitation, may include training examples with analytical queries that have clear “measure vs. dimension” or “measure vs. measure” relations that can be visualized as charts or plots. Determination of whether the example is suitable for augmentation is performed for each, or a subset, of the examples in the original training dataset that is accessed in accordance with (g) and (a).

Additionally or alternatively, visualization training datasets may be generated by modifying examples in the visualization query dataset using the VIS2VIS pipeline described in FIG. 6 and FIG. 8 which implements various tools and algorithms to augment a portion, or all, of the training examples that comprise the viz-creation training data. The VIS2VIS pipeline comprises steps (a) through (f) described below that may be performed in any order or in parallel to generate viz-creation training data for training a NL2LF model.
a) An example from the visualization query dataset is accessed that is suitable for transformation into a viz-creation example. This example may be accessed from a visualization query dataset and may comprise (i) a system programming language corresponding to the natural language utterance, (ii) a schema, (iii) a natural language utterance, and (iv) a visualization type presented in the natural language utterance. The natural language utterance associated with the example already comprises a visualization clause that includes a visualization action for the visualization type (e.g., “Bar chart of the maximum employee salary by level”).
b) The system programming language corresponding to the natural language utterance is converted into the MRL logical form compatible with the VIS2VIS pipeline (e.g., OMRL). The system programming language is a non-MRL language and may instead be a system programming language like SQL, PGQL, logical queries, API query languages such as GraphQL, REST, and so forth, that is converted into MRL. The conversion of a system programming language into an MRL/OMRL logical form is described in U.S. patent application Ser. No. 18/209,844. Briefly, a converter/translator is used to convert the system programming language from the visualization query dataset example to MRL logical form.
c) To the schema, one or more visualization-related entities and schema-linking relations that link the one or more visualization-related entities to one or more entities within the schema are added to generate a visualization labeled schema. This may be done by: (i) incorporating one or more visualization-related entities from a viz-enabled schema design into the original schema, and (ii) adding the connections (link attributes) between some of the visualization-related entities and the original schema entities, as described in detail with respect to FIG. 7).
d) The MRL logical form is modified to comprise one or more visualization-related entities and a visualization clause that includes the visualization action for the visualization type. The modifications are based on the visualization labeled schema, from step (c) and the visualization type presented in the natural language utterance. This step generates a visualization creation MRL logical form that corresponds to the natural language utterance, in the same way as described in (e) for the MRL2VIS pipeline. The rationale is to ensure the training examples that were originally constructed for use with a non-MRL logical form will work for training examples that utilize an MRL logical form.
e) A new visualization example is generated by assembling the visualization labeled schema, the natural language utterance, and the visualization creation MRL logical form.
f) Finally, steps (a), (b), (d) and (e) may be repeated or a random or predefined number of examples in the visualization query dataset to generate a portion, or all, of the visualization training dataset of the one or more visualization training datasets, the visualization training dataset comprising the new visualization examples.

In some embodiments, modifying the examples in the visualization query dataset further comprises, that prior to performing step (d), the examples are optionally filtered to determine if they are suitable for augmentation or not based on analysis of their MRL logical form. Analysis of the MRL logical form uses a set of filtering rules (described in Table 4), and steps (d)-(f) may only be performed when the example is determined to be suitable for augmentation. Determination of whether the example is suitable for augmentation is performed for each, or a subset, of the examples in the visualization query dataset that is accessed in accordance with (f) and (a).

At box 1115, visualization training data is generated using the incremental visualization dataset either in addition to, in parallel with, or instead of the MRL2VIS and/or VIS2VIS pipelines described in box 1110. The incremental visualization dataset comprises one or more data annotation and incremental NL templates. This process, described in detail in FIG. 6 and FIG. 9, further refines the meaning of existing visualization queries. Briefly, generating viz-incremental training data for training a NL2LF model, using the incremental visualization dataset, comprises steps (a) through (f) described below.
a) An incremental NL template and data annotation from the incremental visualization dataset are accessed. The incremental natural language template comprises a library of different text to be used for an incremental use-case type to be added to a visualization incremental utterance. The data annotation comprises a base utterance, an input MRL logical form associated with the incremental use-case type, an incremental use-case type to be used in the visualization example utterance, and a schema.
b) The original schema in each data annotation(s) may be extended to include one or more visualization-related entities and schema-linking relations that link the one or more visualization-related entities to one or more entities within the schema are added to generate a visualization labeled schema. This process may be done by: (i) incorporating one or more visualization-related entities from a viz-enabled schema design into the original schema, and (ii) adding the connections (link attributes) between some of the visualization-related entities and the original schema entities, as described in detail with respect to FIG. 7).
c) Based on the incremental natural language template, the base utterance, and the incremental use-case type, a visualization example utterance is composed that comprises a visualization action for the incremental use-case type. For this to occur, the specified incremental use-case with a visualization action (e.g., add/remove filter, add/remove/replace columns, sort, etc.) and the base NL utterance are extracted from the data annotation. Then, using the different utterance forms/phrasing provided by the NL templates (e.g., “add”, “enable”, “include”, “insert”, “install”, “introduce”, “set up”, etc.), the final output utterance is composed that is used in the final training data.
d) A visualization incremental MRL logical form is constructed based on the input MRL logical form and a set of MRL logical form construction rules (see Table 8) defined for the incremental use-case type. In other words, a look-up table provides one or more MRL logical form construction rules defined for the incremental use-case type from the data annotations. Then, the one or more MRL logical form construction rules are used to construct the viz-incremental logical form based on the input MRL logical form.
e) By assembling the visualization labeled schema, the visualization example utterance, and the visualization incremental MRL logical form, a new visualization example is generated.
f) Finally, steps (a) and (c)-(e) may be repeated for a random or predefined number of examples to generate a visualization training dataset of the one or more visualization training datasets, the visualization training dataset comprising the new visualization examples.

At block 1120, visualization training data is generated using the manipulation visualization dataset either in addition to, in parallel with, or instead of the MRL2VIS and/or VIS2VIS pipelines described in box 1110, and/or the use of the incremental visualization dataset. The manipulation visualization dataset comprises one or more manipulation templates that are used to generate viz-manipulation training data for training a NL2LF model. This process, described in detail in FIG. 6 and FIG. 10, modifies the appearance of a visualization. Uniquely, the visualization training examples are schema agnostic as they do not refer to any schema attribute/entity. Generating the examples, using the manipulation visualization dataset, comprises steps (a) through (c) described below.
a) A manipulation template from the manipulation visualization dataset is accessed. The manipulation template comprises a NL utterance definition and a corresponding MRL logical form definition for a visualization manipulation use-case. Further, they provide the values that serve as the template definition. Some of the values are only used for the NL utterance (e.g., subjects like “chart”, “viz”; verbs like “change”, “switch”, etc.). Other values (e.g., chart-type values) are used for both the utterance and OMRQL. The manipulation template may be used by a NL+OMRQL composer which selects values from the template to generate the visualization example utterance and the corresponding visualization manipulation MRL logical form.
b) A new visualization example is generated by assembling the visualization example utterance and the visualization manipulation MRL logical form.
c) Steps (a) and (b) may be repeated for a random or predefined number of examples to generate a visualization training dataset of the one or more visualization training datasets, the visualization training dataset comprising the new visualization examples.

At block 1125, the original training dataset is combined with the one or more visualization training datasets (generated from boxes 1110, 1115, and/or 1120) to generate an augmented training dataset. Multiple training examples generated using template and data generation algorithms (i.e., synthetic data) and/or multiple training examples leveraging existing training data (i.e., data augmentation) may be combined with the original training examples to generate the augmented training data set. Combining the training examples may include creating batches of mixed examples from the original training dataset and the one or more visualization training datasets and then storing the batches of mixed examples.

At box 1130, the augmented training dataset is used to train a machine learning model (e.g., a NL2LF model) to convert a natural language utterance into meaning representation language (MRL) logical form that includes one or more visualization actions.

In some instances, the augmented training data set is sampled to ensure that an appropriate amount of the original and new training data is used. Training the machine learning model using the augmented training data set includes sampling training values from the augmented training data set based on a sampling rate and training the machine learning model using the sampled training values. For example, the sampling rate for the new data (including the augmentation examples) is tuned to improve accuracy on targeted test sets and minimize regressions on other model evaluation test sets. The new data and original training data are combined based on the sampling rates determined. Further, the augmented training data can be used as training data and/or testing data. In some instances, synthetic training data is generated using the original training data so that machine learning systems are exposed to variations of training data. Alternatively, or additionally, synthetic augmented testing data is generated to test the level of robustness of the systems against variations of utterances.

### VI. Illustrative Systems

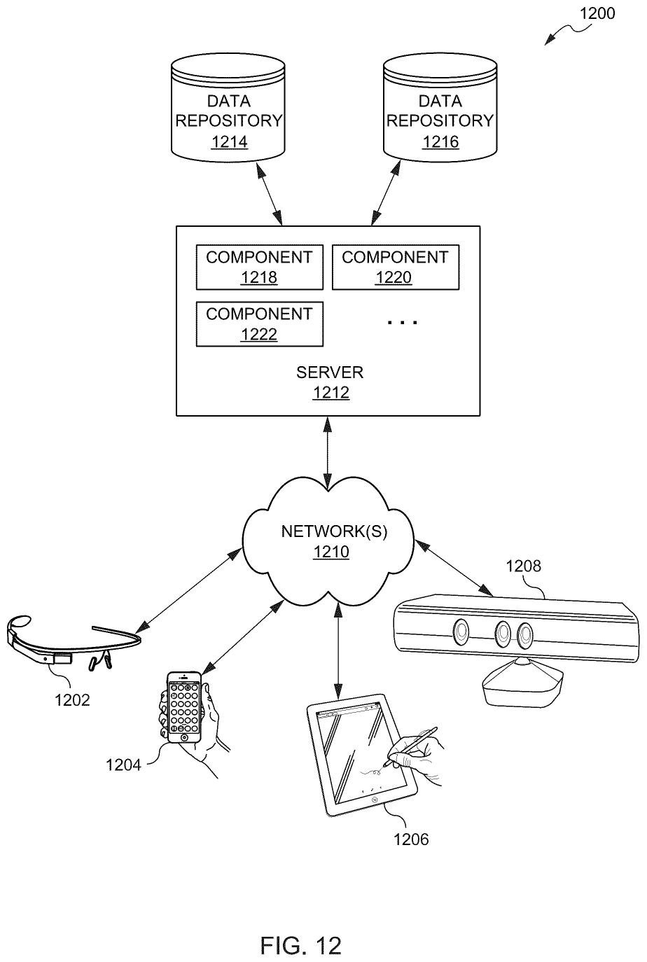

FIG. 12 depicts a simplified diagram of a distributed system 1200. In the illustrated example, distributed system 1200 includes one or more client computing devices 1202, 1204, 1206, and 1208, coupled to a server 1212 via one or more communication networks 1210. Clients computing devices 1202, 1204, 1206, and 1208 may be configured to execute one or more applications.

In various examples, server 1212 may be adapted to run one or more services or software applications that enable one or more embodiments described in this disclosure. In certain examples, server 1212 may also provide other services or software applications that may include non-virtual and virtual environments. In some examples, these services may be offered as web-based or cloud services, such as under a Software as a Service (SaaS) model to the users of client computing devices 1202, 1204, 1206, and/or 1208. Users operating client computing devices 1202, 1204, 1206, and/or 1208 may in turn utilize one or more client applications to interact with server 1212 to utilize the services provided by these components.

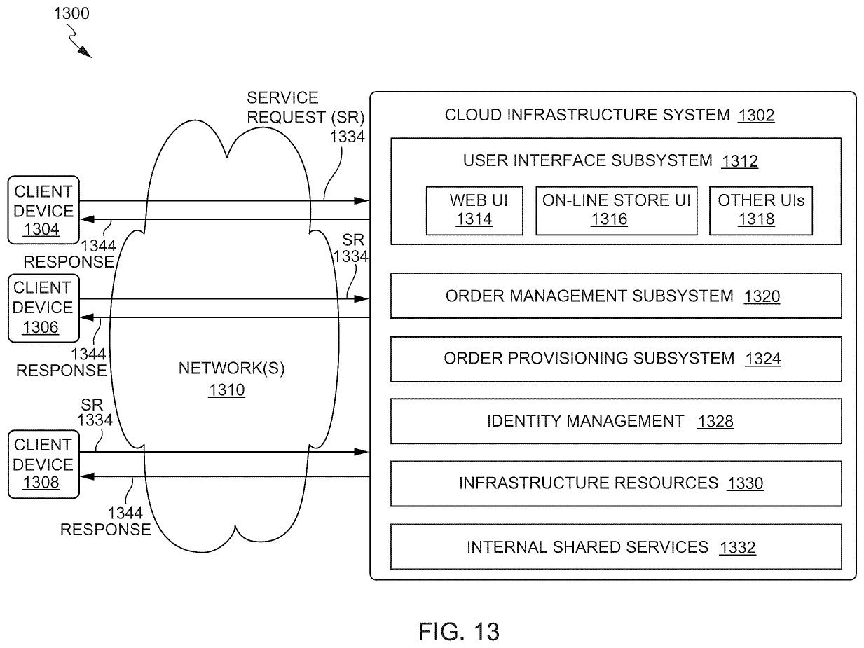

In the configuration depicted in FIG. 12, server 1212 may include one or more components 1218, 1220 and 1222 that implement the functions performed by server 1212. These components may include software components that may be executed by one or more processors, hardware components, or combinations thereof. It should be appreciated that various different system configurations are possible, which may be different from distributed system 1200. The example shown in FIG. 13 is thus one example of a distributed system for implementing an example system and is not intended to be limiting.

Users may use client computing devices 1202, 1204, 1206, and/or 1208 to execute one or more applications, models or chatbots, which may generate one or more events or models that may then be implemented or serviced in accordance with the teachings of this disclosure. A client device may provide an interface that enables a user of the client device to interact with the client device. The client device may also output information to the user via this interface. Although FIG. 13 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 1210 may be any type of network familiar to those skilled in the art that may support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1210 may be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth, and/or any other wireless protocol), and/or any combination of these and/or other networks.

Server 1212 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 1212 may include one or more virtual machines running virtual operating systems, or other computing architectures involving virtualization such as one or more flexible pools of logical storage devices that may be virtualized to maintain virtual storage devices for the server. In various examples, server 1212 may be adapted to run one or more services or software applications that provide the functionality described in the foregoing disclosure.

The computing systems in server 1212 may run one or more operating systems including any of those discussed above, as well as any commercially available server operating system. Server 1212 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 1212 may include one or more applications to analyze and consolidate data feeds and/or event updates received from users of client computing devices 1202, 1204, 1206, and 1208. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1212 may also include one or more applications to display the data feeds and/or real-time events via one or more display devices of client computing devices 1202, 1204, 1206, and 1208.

Distributed system 1200 may also include one or more data repositories 1214, 1216. These data repositories may be used to store data and other information in certain examples. For example, one or more of the data repositories 1214, 1216 may be used to store information such as information related to chatbot performance or generated models for use by chatbots used by server 1212 when performing various functions in accordance with various embodiments. Data repositories 1214, 1216 may reside in a variety of locations. For example, a data repository used by server 1212 may be local to server 1212 or may be remote from server 1212 and in communication with server 1212 via a network-based or dedicated connection. Data repositories 1214, 1216 may be of different types. In certain examples, a data repository used by server 1212 may be a database, for example, a relational database, such as databases provided by Oracle Corporation® and other vendors. One or more of these databases may be adapted to enable storage, update, and retrieval of data to and from the database in response to SQL-formatted commands.

In certain examples, one or more of data repositories 1214, 1216 may also be used by applications to store application data. The data repositories used by applications may be of different types such as, for example, a key-value store repository, an object store repository, or a general storage repository supported by a file system.

In certain examples, the functionalities described in this disclosure may be offered as services via a cloud environment. FIG. 13 is a simplified block diagram of a cloud-based system environment in which various services may be offered as cloud services in accordance with certain examples. In the example depicted in FIG. 13, cloud infrastructure system 1302 may provide one or more cloud services that may be requested by users using one or more client computing devices 1304, 1306, and 1308. Cloud infrastructure system 1302 may comprise one or more computers and/or servers that may include those described above for server 1212. The computers in cloud infrastructure system 1302 may be organized as general purpose computers, specialized server computers, server farms, server clusters, or any other appropriate arrangement and/or combination.

Network(s) 1310 may facilitate communication and exchange of data between clients 1304, 1306, and 1308 and cloud infrastructure system 1302. Network(s) 1310 may include one or more networks. The networks may be of the same or different types. Network(s) 1310 may support one or more communication protocols, including wired and/or wireless protocols, for facilitating the communications.

The example depicted in FIG. 13 is only one example of a cloud infrastructure system and is not intended to be limiting. It should be appreciated that, in some other examples, cloud infrastructure system 1302 may have more or fewer components than those depicted in FIG. 13, may combine two or more components, or may have a different configuration or arrangement of components. For example, although FIG. 13 depicts three client computing devices, any number of client computing devices may be supported in alternative examples.

The term cloud service is generally used to refer to a service that is made available to users on demand and via a communication network such as the Internet by systems (e.g., cloud infrastructure system 1302) of a service provider. Typically, in a public cloud environment, servers and systems that make up the cloud service provider's system are different from the customer's own on-premise servers and systems. The cloud service provider's systems are managed by the cloud service provider. Customers may thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, California, such as middleware services, database services, Java cloud services, and others.

In certain examples, cloud infrastructure system 1302 may provide one or more cloud services using different models such as under a Software as a Service (SaaS) model, a Platform as a Service (PaaS) model, an Infrastructure as a Service (IaaS) model, and others, including hybrid service models. Cloud infrastructure system 1302 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 1302. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 1302. Cloud infrastructure system 1302 then performs processing to provide the services requested in the customer's subscription order. For example, a user may use utterances to request the cloud infrastructure system to take a certain action (e.g., an intent), as described above, and/or provide services for a chatbot system as described herein. Cloud infrastructure system 1302 may be configured to provide one or even multiple cloud services.

Cloud infrastructure system 1302 may provide the cloud services via different deployment models. In a public cloud model, cloud infrastructure system 1302 may be owned by a third party cloud services provider and the cloud services are offered to any general public customer, where the customer may be an individual or an enterprise. In certain other examples, under a private cloud model, cloud infrastructure system 1302 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other examples, under a community cloud model, the cloud infrastructure system 1302 and the services provided may be shared by several organizations in a related community. Various other models such as hybrids of the above mentioned models may also be used.

Client computing devices 1304, 1306, and 1308 may be of different types (such as client computing devices 1202, 1204, 1206, and 1208 depicted in FIG. 12) and may be capable of operating one or more client applications. A user may use a client device to interact with cloud infrastructure system 1302, such as to request a service provided by cloud infrastructure system 1302. For example, a user may use a client device to request information or action from a chatbot as described in this disclosure.

In some examples, the processing performed by cloud infrastructure system 1302 for providing services may involve model training and deployment. This analysis may involve using, analyzing, and manipulating data sets to train and deploy one or more models. This analysis may be performed by one or more processors, possibly processing the data in parallel, performing simulations using the data, and the like. For example, big data analysis may be performed by cloud infrastructure system 1302 for generating and training one or more models for a chatbot system. The data used for this analysis may include structured data (e.g., data stored in a database or structured according to a structured model) and/or unstructured data (e.g., data blobs (binary large objects)).

As depicted in the example in FIG. 13, cloud infrastructure system 1302 may include infrastructure resources 1330 that are utilized for facilitating the provision of various cloud services offered by cloud infrastructure system 1302. Infrastructure resources 1330 may include, for example, processing resources, storage or memory resources, networking resources, and the like. In certain examples, the storage virtual machines that are available for servicing storage requested from applications may be part of cloud infrastructure system 1302. In other examples, the storage virtual machines may be part of different systems.

In certain examples, to facilitate efficient provisioning of these resources for supporting the various cloud services provided by cloud infrastructure system 1302 for different customers, the resources may be bundled into sets of resources or resource modules (also referred to as “pods”). Each resource module or pod may comprise a pre-integrated and optimized combination of resources of one or more types. In certain examples, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1302 may itself internally use services 1332 that are shared by different components of cloud infrastructure system 1302 and which facilitate the provisioning of services by cloud infrastructure system 1302. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 1302 may comprise multiple subsystems. These subsystems may be implemented in software, or hardware, or combinations thereof. As depicted in FIG. 13, the subsystems may include a user interface subsystem 1312 that enables users or customers of cloud infrastructure system 1302 to interact with cloud infrastructure system 1302. User interface subsystem 1312 may include various different interfaces such as a web interface 1314, an online store interface 1316 where cloud services provided by cloud infrastructure system 1302 are advertised and are purchasable by a consumer, and other interfaces 1318. For example, a customer may, using a client device, request (service request 1334) one or more services provided by cloud infrastructure system 1302 using one or more of interfaces 1314, 1316, and 1318. For example, a customer may access the online store, browse cloud services offered by cloud infrastructure system 1302, and place a subscription order for one or more services offered by cloud infrastructure system 1302 that the customer wishes to subscribe to. The service request may include information identifying the customer and one or more services that the customer desires to subscribe to. For example, a customer may place a subscription order for a service offered by cloud infrastructure system 1302. As part of the order, the customer may provide information identifying a chatbot system for which the service is to be provided and optionally one or more credentials for the chatbot system.

In certain examples, such as the example depicted in FIG. 13, cloud infrastructure system 1302 may comprise an order management subsystem (OMS) 1320 that is configured to process the new order. As part of this processing, OMS 1320 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 1320 may then invoke the order provisioning subsystem (OPS) 1324 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 1324 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

In certain examples, setup phase processing, as described above, may be performed by cloud infrastructure system 1302 as part of the provisioning process. Cloud infrastructure system 1302 may generate an application ID and select a storage virtual machine for an application from among storage virtual machines provided by cloud infrastructure system 1302 itself or from storage virtual machines provided by other systems other than cloud infrastructure system 1302.

Cloud infrastructure system 1302 may send a response or notification 1344 to the requesting customer to indicate when the requested service is now ready for use. In some instances, information (e.g., a link) may be sent to the customer that enables the customer to start using and availing the benefits of the requested services. In certain examples, for a customer requesting the service, the response may include a chatbot system ID generated by cloud infrastructure system 1302 and information identifying a chatbot system selected by cloud infrastructure system 1302 for the chatbot system corresponding to the chatbot system ID.

Cloud infrastructure system 1302 may provide services to multiple customers. For each customer, cloud infrastructure system 1302 is responsible for managing information related to one or more subscription orders received from the customer, maintaining customer data related to the orders, and providing the requested services to the customer. Cloud infrastructure system 1302 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 1302 may provide services to multiple customers in parallel. Cloud infrastructure system 1302 may store information for these customers, including possibly proprietary information. In certain examples, cloud infrastructure system 1302 comprises an identity management subsystem (IMS) 1328 that is configured to manage customer information and provide the separation of the managed information such that information related to one customer is not accessible by another customer. IMS 1328 may be configured to provide various security-related services such as identity services, such as information access management, authentication and authorization services, services for managing customer identities and roles and related capabilities, and the like.

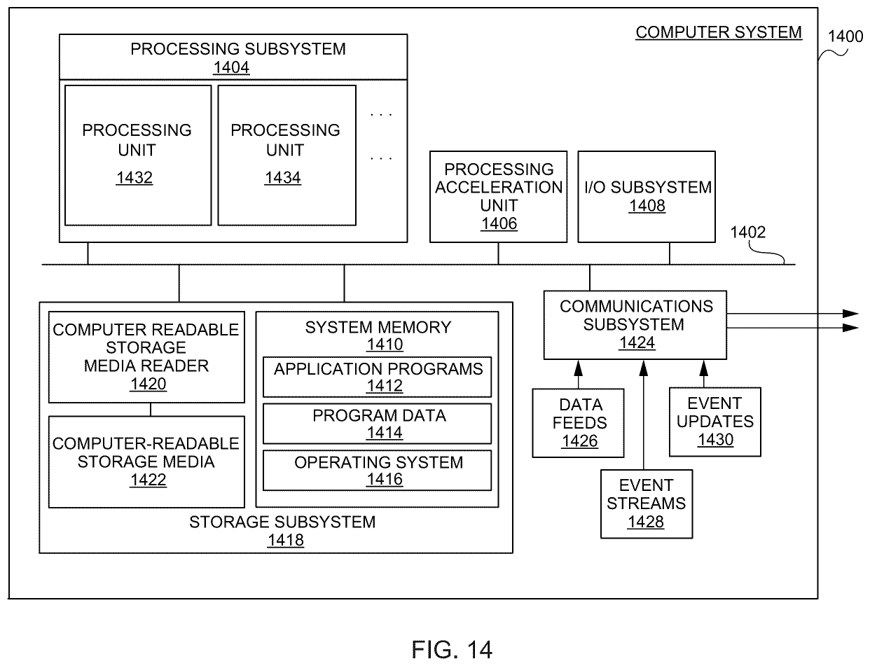

FIG. 14 illustrates an example of computer system 1400. In some examples, computer system 1400 may be used to implement any of the digital assistant or chatbot systems within a distributed environment, and various servers and computer systems described above. As shown in FIG. 14, computer system 1400 includes various subsystems including a processing subsystem 1404 that communicates with a number of other subsystems via a bus subsystem 1402. These other subsystems may include a processing acceleration unit 1406, an I/O subsystem 1408, a storage subsystem 1418, and a communications subsystem 1424. Storage subsystem 1418 may include non-transitory computer-readable storage media including storage media 1422 and a system memory 1410.

Bus subsystem 1402 provides a mechanism for letting the various components and subsystems of computer system 1400 communicate with each other as intended. Although bus subsystem 1402 is shown schematically as a single bus, alternative examples of the bus subsystem may utilize multiple buses. Bus subsystem 1402 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 1404 controls the operation of computer system 1400 and may comprise one or more processors, application specific integrated circuits (ASICs), or field programmable gate arrays (FPGAs). The processors may include be single core or multicore processors. The processing resources of computer system 1400 may be organized into one or more processing units 1432, 1434, etc. A processing unit may include one or more processors, one or more cores from the same or different processors, a combination of cores and processors, or other combinations of cores and processors. In some examples, processing subsystem 1404 may include one or more special purpose co-processors such as graphics processors, digital signal processors (DSPs), or the like. In some examples, some or all of the processing units of processing subsystem 1404 may be implemented using customized circuits, such as application specific integrated circuits (ASICs), or field programmable gate arrays (FPGAs).

In some examples, the processing units in processing subsystem 1404 may execute instructions stored in system memory 1410 or on computer readable storage media 1422. In various examples, the processing units may execute a variety of programs or code instructions and may maintain multiple concurrently executing programs or processes. At any given time, some or all of the program code to be executed may be resident in system memory 1410 and/or on computer-readable storage media 1422 including potentially on one or more storage devices. Through suitable programming, processing subsystem 1404 may provide various functionalities described above. In instances where computer system 1400 is executing one or more virtual machines, one or more processing units may be allocated to each virtual machine.

In certain examples, a processing acceleration unit 1406 may optionally be provided for performing customized processing or for off-loading some of the processing performed by processing subsystem 1404 so as to accelerate the overall processing performed by computer system 1400.

I/O subsystem 1408 may include devices and mechanisms for inputting information to computer system 1400 and/or for outputting information from or via computer system 1400. In general, use of the term input device is intended to include all possible types of devices and mechanisms for inputting information to computer system 1400. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 1400 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 1418 provides a repository or data store for storing information and data that is used by computer system 1400. Storage subsystem 1418 provides a tangible non-transitory computer-readable storage medium for storing the basic programming and data constructs that provide the functionality of some examples. Storage subsystem 14112 may store software (e.g., programs, code modules, instructions) that when executed by processing subsystem 1404 provides the functionality described above. The software may be executed by one or more processing units of processing subsystem 1404. Storage subsystem 1418 may also provide authentication in accordance with the teachings of this disclosure.

Storage subsystem 1418 may include one or more non-transitory memory devices, including volatile and non-volatile memory devices. As shown in FIG. 14, storage subsystem 1418 includes a system memory 1410 and a computer-readable storage media 1422. System memory 1410 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1400, such as during start-up, may typically be stored in the ROM. The RAM typically contains data and/or program modules that are presently being operated and executed by processing subsystem 1404. In some implementations, system memory 1410 may include multiple different types of memory, such as static random access memory (SRAM), dynamic random access memory (DRAM), and the like.

By way of example, and not limitation, as depicted in FIG. 14, system memory 1410 may load application programs 1412 that are being executed, which may include various applications such as Web browsers, mid-tier applications, relational database management systems (RDBMS), etc., program data 1414, and an operating system 1416. By way of example, operating system 1416 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome OS®, and the like) and/or mobile operating systems such as iOS, Windows® Phone, Android® OS, BlackBerry® OS, Palm® OS operating systems, and others.

Computer-readable storage media 1422 may store programming and data constructs that provide the functionality of some examples. Computer-readable storage media 1422 may provide storage of computer-readable instructions, data structures, program modules, and other data for computer system 1400. Software (programs, code modules, instructions) that, when executed by processing subsystem 1404 provides the functionality described above, may be stored in storage subsystem 1418. By way of example, computer-readable storage media 1422 may include non-volatile memory such as a hard disk drive, a magnetic disk drive, an optical disk drive such as a CD ROM, DVD, a Blu-Ray® disk, or other optical media. Computer-readable storage media 1422 may include, but is not limited to, Zip® drives, flash memory cards, universal serial bus (USB) flash drives, secure digital (SD) cards, DVD disks, digital video tape, and the like. Computer-readable storage media 1422 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain examples, storage subsystem 1418 may also include a computer-readable storage media reader 1420 that may further be connected to computer-readable storage media 1422. Reader 1420 may receive and be configured to read data from a memory device such as a disk, a flash drive, etc.

In certain examples, computer system 1400 may support virtualization technologies, including but not limited to virtualization of processing and memory resources. For example, computer system 1400 may provide support for executing one or more virtual machines. In certain examples, computer system 1400 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1400. Accordingly, multiple operating systems may potentially be run concurrently by computer system 1400.

Communications subsystem 1424 provides an interface to other computer systems and networks. Communications subsystem 1424 serves as an interface for receiving data from and transmitting data to other systems from computer system 1400. For example, communications subsystem 1424 may enable computer system 1400 to establish a communication channel to one or more client devices via the Internet for receiving and sending information from and to the client devices. For example, when computer system 1400 is used to implement bot system 106 depicted in FIG. 1, the communication subsystem may be used to communicate with a chatbot system selected for an application.

Communication subsystem 1424 may support both wired and/or wireless communication protocols. In certain examples, communications subsystem 1424 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some examples, communications subsystem 1424 may provide wired network connectivity (e.g., Ethernet) in addition to or instead of a wireless interface.

Communication subsystem 1424 may receive and transmit data in various forms. In some examples, in addition to other forms, communications subsystem 1424 may receive input communications in the form of structured and/or unstructured data feeds 1426, event streams 1428, event updates 1430, and the like. For example, communications subsystem 1424 may be configured to receive (or send) data feeds 1426 in real-time from users of social media networks and/or other communication services such as Twitter® feeds, Facebook® updates, web feeds such as Rich Site Summary (RSS) feeds, and/or real-time updates from one or more third party information sources.

In certain examples, communications subsystem 1424 may be configured to receive data in the form of continuous data streams, which may include event streams 1428 of real-time events and/or event updates 1430, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1424 may also be configured to communicate data from computer system 1400 to other computer systems or networks. The data may be communicated in various different forms such as structured and/or unstructured data feeds 1426, event streams 1428, event updates 1430, and the like to one or more databases that may be in communication with one or more streaming data source computers coupled to computer system 1400.

Computer system 1400 may be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 1400 depicted in FIG. 14 is intended only as a specific example. Many other configurations having more or fewer components than the system depicted in FIG. 14 are possible. Based on the disclosure and teachings provided herein, it should be appreciated there are other ways and/or methods to implement the various examples.

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed:

1. A computer-implemented method comprising:
accessing an original training dataset, a visualization query dataset, an incremental visualization dataset, a manipulation visualization dataset, or any combination thereof;
generating one or more visualization training datasets by: (i) modifying examples in the original training dataset, the visualization query dataset, or both to include visualization actions, (ii) generating examples, using the incremental visualization dataset, the manipulation visualization dataset, or both, that include visualization actions, or (iii) both (i) and (ii);
augmenting the original training dataset by adding the one or more visualization training datasets to the original training dataset to generate an augmented training dataset; and
training, using the augmented training dataset, a machine learning model to convert a natural language utterance into meaning representation language (MRL) logical form that includes one or more visualization actions.

2. The computer-implemented method of claim 1, wherein: (i) each example in the original training dataset comprises a natural language utterance, a MRL logical form corresponding to the natural language utterance, and a schema, (ii) each example in the visualization query dataset comprises a natural language utterance, a system programming language corresponding to the natural language utterance, a visualization type presented in the natural language utterance, and a schema, (iii) the incremental visualization dataset comprises one or more data annotation and incremental natural language templates, and (iv) the manipulation visualization dataset comprises one or more manipulation templates.

3. The computer-implemented method of claim 2, wherein modifying the examples in the original training dataset comprises:
(a) accessing an example from the original training dataset;
(b) adding, to the schema associated with the example, one or more visualization-related entities and schema-linking relations that link the one or more visualization-related entities to one or more entities within the schema to generate a visualization labeled schema;
(c) selecting a visualization type for the example based on constraints of the MRL logical form and popularity scores associated to each visualization type;
(d) adding a visualization clause to the natural language utterance associated with the example using a visualization clause template and the visualization type selected for the example to generate a visualization creation utterance, wherein the visualization clause includes a visualization action for the visualization type;
(e) modifying, based on the visualization labeled schema and the visualization type selected for the example, the MRL logical form associated with the example to generate a visualization creation MRL logical form that corresponds to the visualization creation utterance, wherein the visualization creation MRL logical form comprises one or more visualization-related entities and a visualization clause that includes the visualization action for the visualization type;
(f) assembling the visualization labeled schema, the visualization creation utterance, and the visualization creation MRL logical form to generate a new visualization example; and
(g) repeating steps (a) and (c)-(f) for a random or predefined number of examples in the original training dataset to generate a visualization training dataset of the one or more visualization training datasets, the visualization training dataset comprising the new visualization examples.

4. The computer-implemented method of claim 2, wherein modifying the examples in the visualization query dataset comprises:
(a) accessing an example from the visualization query dataset, wherein the natural language utterance associated with the example comprises a visualization clause that includes a visualization action for the visualization type;
(b) converting the system programming language into MRL logical form corresponding to the natural language utterance;
(c) adding, to the schema, one or more visualization-related entities and schema-linking relations that link the one or more visualization-related entities to one or more entities within the schema to generate a visualization labeled schema;
(d) modifying, based on the visualization labeled schema and the visualization type presented in the natural language utterance, the MRL logical form to generate a visualization creation MRL logical form that corresponds to the natural language utterance, wherein the visualization creation MRL logical form comprises one or more visualization-related entities and a visualization clause that includes the visualization action for the visualization type;
(e) assembling the visualization labeled schema, the natural language utterance, and the visualization creation MRL logical form to generate a new visualization example; and
(f) repeating steps (a), (b), (d) and (e) for a random or predefined number of examples in the visualization query dataset to generate a visualization training dataset of the one or more visualization training datasets, the visualization training dataset comprising the new visualization examples.

5. The computer-implemented method of claim 2, wherein generating the examples, using the incremental visualization dataset, comprises:
(a) accessing an incremental natural language template and data annotation from the incremental visualization dataset, wherein the incremental natural language template comprises a library of different text to be used for an incremental use-case type to be added to a visualization incremental utterance, and wherein the data annotation comprises a base utterance, an input MRL logical form, an incremental use-case type to be used in the visualization example utterance, and a schema;
(b) adding, to the schema, one or more visualization-related entities and schema-linking relations that link the one or more visualization-related entities to one or more entities within the schema to generate a visualization labeled schema;
(c) composing, based on the incremental natural language template, the base utterance, and the incremental use-case type, a visualization example utterance that comprises a visualization action for the incremental use-case type;
(d) constructing, based on the input MRL logical form and a set of MRL logical form construction rules defined for the incremental use-case type, a visualization incremental MRL logical form;
(e) assembling the visualization labeled schema, the visualization example utterance, and the visualization incremental MRL logical form to generate a new visualization example; and
(f) repeating steps (a) and (c)-(e) for a random or predefined number of examples to generate a visualization training dataset of the one or more visualization training datasets, the visualization training dataset comprising the new visualization examples.

6. The computer-implemented method of claim 2, wherein generating the examples, using the manipulation visualization dataset, comprises:
(a) accessing a manipulation template from the manipulation visualization dataset, wherein the manipulation template comprises a natural language utterance definition and a corresponding MRL logical form definition for a visualization manipulation use-case;
(b) composing, using the manipulation template, a new visualization example comprising a visualization example utterance and a corresponding visualization manipulation MRL logical form;
(c) repeating steps (a) and (b) for a random or predefined number of examples to generate a visualization training dataset of the one or more visualization training datasets, the visualization training dataset comprising the new visualization examples.

7. The computer-implemented method of claim 1, wherein modifying the examples in the original training dataset, the visualization query dataset, or both further comprises, after adding, to the schema associated with the example, determining whether the example is suitable for augmentation based on analysis of the MRL logical form using a set of filtering rules, and only performing (c)-(f) when the example is determined to be suitable for augmentation, and wherein the determination of whether the example is suitable for augmentation is performed for each example in the original training dataset that is accessed in accordance with (g) and (a).

8. One or more non-transitory computer-readable media storing instructions which, when executed by one or more processors, cause a system to perform operations comprising:
accessing an original training dataset, a visualization query dataset, an incremental visualization dataset, a manipulation visualization dataset, or any combination thereof;
generating one or more visualization training datasets by: (i) modifying examples in the original training dataset, the visualization query dataset, or both to include visualization actions, (ii) generating examples, using the incremental visualization dataset, the manipulation visualization dataset, or both, that include visualization actions, or (iii) both (i) and (ii);
augmenting the original training dataset by adding the one or more visualization training datasets to the original training dataset to generate an augmented training dataset; and
training, using the augmented training dataset, a machine learning model to convert a natural language utterance into meaning representation language (MRL) logical form that includes one or more visualization actions.

9. The one or more non-transitory computer-readable media of claim 8, wherein: (i) each example in the original training dataset comprises a natural language utterance, a MRL logical form corresponding to the natural language utterance, and a schema, (ii) each example in the visualization query dataset comprises a natural language utterance, a system programming language corresponding to the natural language utterance, a visualization type presented in the natural language utterance, and a schema, (iii) the incremental visualization dataset comprises one or more data annotation and incremental natural language templates, and (iv) the manipulation visualization dataset comprises one or more manipulation templates.

10. The one or more non-transitory computer-readable media of claim 9, wherein modifying the examples in the original training dataset comprises:
(a) accessing an example from the original training dataset;
(b) adding, to the schema associated with the example, one or more visualization-related entities and schema-linking relations that link the one or more visualization-related entities to one or more entities within the schema to generate a visualization labeled schema;
(c) selecting a visualization type for the example based on constraints of the MRL logical form and popularity scores associated to each visualization type;
(d) adding a visualization clause to the natural language utterance associated with the example using a visualization clause template and the visualization type selected for the example to generate a visualization creation utterance, wherein the visualization clause includes a visualization action for the visualization type;
(e) modifying, based on the visualization labeled schema and the visualization type selected for the example, the MRL logical form associated with the example to generate a visualization creation MRL logical form that corresponds to the visualization creation utterance, wherein the visualization creation MRL logical form comprises one or more visualization-related entities and a visualization clause that includes the visualization action for the visualization type;
(f) assembling the visualization labeled schema, the visualization creation utterance, and the visualization creation MRL logical form to generate a new visualization example; and
(g) repeating steps (a) and (c)-(f) for a random or predefined number of examples in the original training dataset to generate a visualization training dataset of the one or more visualization training datasets, the visualization training dataset comprising the new visualization examples.

11. The one or more non-transitory computer-readable media of claim 9, wherein modifying the examples in the visualization query dataset comprises:
(a) accessing an example from the visualization query dataset, wherein the natural language utterance associated with the example comprises a visualization clause that includes a visualization action for the visualization type;
(b) converting the system programming language into MRL logical form corresponding to the natural language utterance;
(c) adding, to the schema, one or more visualization-related entities and schema-linking relations that link the one or more visualization-related entities to one or more entities within the schema to generate a visualization labeled schema;
(d) modifying, based on the visualization labeled schema and the visualization type presented in the natural language utterance, the MRL logical form to generate a visualization creation MRL logical form that corresponds to the natural language utterance, wherein the visualization creation MRL logical form comprises one or more visualization-related entities and a visualization clause that includes the visualization action for the visualization type;
(e) assembling the visualization labeled schema, the natural language utterance, and the visualization creation MRL logical form to generate a new visualization example; and
(f) repeating steps (a), (b), (d) and (e) for a random or predefined number of examples in the visualization query dataset to generate a visualization training dataset of the one or more visualization training datasets, the visualization training dataset comprising the new visualization examples.

12. The one or more non-transitory computer-readable media of claim 9, wherein generating the examples, using the incremental visualization dataset, comprises:
(a) accessing an incremental natural language template and data annotation from the incremental visualization dataset, wherein the incremental natural language template comprises a library of different text to be used for an incremental use-case type to be added to a visualization incremental utterance, and wherein the data annotation comprises a base utterance, an input MRL logical form, an incremental use-case type to be used in the visualization example utterance, and a schema;
(b) adding, to the schema, one or more visualization-related entities and schema-linking relations that link the one or more visualization-related entities to one or more entities within the schema to generate a visualization labeled schema;
(c) composing, based on the incremental natural language template, the base utterance, and the incremental use-case type, a visualization example utterance that comprises a visualization action for the incremental use-case type;
(d) constructing, based on the input MRL logical form and a set of MRL logical form construction rules defined for the incremental use-case type, a visualization incremental MRL logical form;
(e) assembling the visualization labeled schema, the visualization example utterance, and the visualization incremental MRL logical form to generate a new visualization example; and
(f) repeating steps (a) and (c)-(e) for a random or predefined number of examples to generate a visualization training dataset of the one or more visualization training datasets, the visualization training dataset comprising the new visualization examples.

13. The one or more non-transitory computer-readable media of claim 9, wherein generating the examples, using the manipulation visualization dataset, comprises:
(a) accessing a manipulation template from the manipulation visualization dataset, wherein the manipulation template comprises a natural language utterance definition and a corresponding MRL logical form definition for a visualization manipulation use-case;
(b) composing, using the manipulation template, a new visualization example comprising a visualization example utterance and a corresponding visualization manipulation MRL logical form;
(c) repeating steps (a) and (b) for a random or predefined number of examples to generate a visualization training dataset of the one or more visualization training datasets, the visualization training dataset comprising the new visualization examples.

14. The one or more non-transitory computer-readable media of claim 8, wherein modifying the examples in the original training dataset, the visualization query dataset, or both further comprises, after adding, to the schema associated with the example, determining whether the example is suitable for augmentation based on analysis of the MRL logical form using a set of filtering rules, and only performing (c)-(f) when the example is determined to be suitable for augmentation, and wherein the determination of whether the example is suitable for augmentation is performed for each example in the original training dataset that is accessed in accordance with (g) and (a).

15. A system comprising:
one or more processors; and
one or more computer-readable media storing instructions which, when executed by the one or more processors, cause the system to perform operations comprising:
accessing an original training dataset, a visualization query dataset, an incremental visualization dataset, a manipulation visualization dataset, or any combination thereof;
generating one or more visualization training datasets by: (i) modifying examples in the original training dataset, the visualization query dataset, or both to include visualization actions, (ii) generating examples, using the incremental visualization dataset, the manipulation visualization dataset, or both, that include visualization actions, or (iii) both (i) and (ii);
augmenting the original training dataset by adding the one or more visualization training datasets to the original training dataset to generate an augmented training dataset; and
training, using the augmented training dataset, a machine learning model to convert a natural language utterance into meaning representation language (MRL) logical form that includes one or more visualization actions.

16. The system of claim 15, wherein: (i) each example in the original training dataset comprises a natural language utterance, a MRL logical form corresponding to the natural language utterance, and a schema, (ii) each example in the visualization query dataset comprises a natural language utterance, a system programming language corresponding to the natural language utterance, a visualization type presented in the natural language utterance, and a schema, (iii) the incremental visualization dataset comprises one or more data annotation and incremental natural language templates, and (iv) the manipulation visualization dataset comprises one or more manipulation templates.

17. The system of claim 16, wherein modifying the examples in the original training dataset comprises:
(a) accessing an example from the original training dataset;
(b) adding, to the schema associated with the example, one or more visualization-related entities and schema-linking relations that link the one or more visualization-related entities to one or more entities within the schema to generate a visualization labeled schema;
(c) selecting a visualization type for the example based on constraints of the MRL logical form and popularity scores associated to each visualization type;
(d) adding a visualization clause to the natural language utterance associated with the example using a visualization clause template and the visualization type selected for the example to generate a visualization creation utterance, wherein the visualization clause includes a visualization action for the visualization type;
(e) modifying, based on the visualization labeled schema and the visualization type selected for the example, the MRL logical form associated with the example to generate a visualization creation MRL logical form that corresponds to the visualization creation utterance, wherein the visualization creation MRL logical form comprises one or more visualization-related entities and a visualization clause that includes the visualization action for the visualization type;
(f) assembling the visualization labeled schema, the visualization creation utterance, and the visualization creation MRL logical form to generate a new visualization example; and
(g) repeating steps (a) and (c)-(f) for a random or predefined number of examples in the original training dataset to generate a visualization training dataset of the one or more visualization training datasets, the visualization training dataset comprising the new visualization examples.

18. The system of claim 16, wherein modifying the examples in the visualization query dataset comprises:
(a) accessing an example from the visualization query dataset, wherein the natural language utterance associated with the example comprises a visualization clause that includes a visualization action for the visualization type;
(b) converting the system programming language into MRL logical form corresponding to the natural language utterance;
(c) adding, to the schema, one or more visualization-related entities and schema-linking relations that link the one or more visualization-related entities to one or more entities within the schema to generate a visualization labeled schema;
(d) modifying, based on the visualization labeled schema and the visualization type presented in the natural language utterance, the MRL logical form to generate a visualization creation MRL logical form that corresponds to the natural language utterance, wherein the visualization creation MRL logical form comprises one or more visualization-related entities and a visualization clause that includes the visualization action for the visualization type;
(e) assembling the visualization labeled schema, the natural language utterance, and the visualization creation MRL logical form to generate a new visualization example; and
(f) repeating steps (a), (b), (d) and (e) for a random or predefined number of examples in the visualization query dataset to generate a visualization training dataset of the one or more visualization training datasets, the visualization training dataset comprising the new visualization examples.

19. The system of claim 16, wherein generating the examples, using the incremental visualization dataset, comprises:
(a) accessing an incremental natural language template and data annotation from the incremental visualization dataset, wherein the incremental natural language template comprises a library of different text to be used for an incremental use-case type to be added to a visualization incremental utterance, and wherein the data annotation comprises a base utterance, an input MRL logical form, an incremental use-case type to be used in the visualization example utterance, and a schema;
(b) adding, to the schema, one or more visualization-related entities and schema-linking relations that link the one or more visualization-related entities to one or more entities within the schema to generate a visualization labeled schema;
(c) composing, based on the incremental natural language template, the base utterance, and the incremental use-case type, a visualization example utterance that comprises a visualization action for the incremental use-case type;
(d) constructing, based on the input MRL logical form and a set of MRL logical form construction rules defined for the incremental use-case type, a visualization incremental MRL logical form;
(e) assembling the visualization labeled schema, the visualization example utterance, and the visualization incremental MRL logical form to generate a new visualization example; and
(f) repeating steps (a) and (c)-(e) for a random or predefined number of examples to generate a visualization training dataset of the one or more visualization training datasets, the visualization training dataset comprising the new visualization examples.

20. The system of claim 16, wherein generating the examples, using the manipulation visualization dataset, comprises:
(a) accessing a manipulation template from the manipulation visualization dataset, wherein the manipulation template comprises a natural language utterance definition and a corresponding MRL logical form definition for a visualization manipulation use-case;
(b) composing, using the manipulation template, a new visualization example comprising a visualization example utterance and a corresponding visualization manipulation MRL logical form;
(c) repeating steps (a) and (b) for a random or predefined number of examples to generate a visualization training dataset of the one or more visualization training datasets, the visualization training dataset comprising the new visualization examples.
